(19) United States
(12) Patent Application Publication
(10) Pub. No.: US 2007/0065710 A1
(43) Pub. Date: Mar. 22, 2007

(54) Fuel Cell

(75) Inventors: Tetsuya Ogawa, Wako-shi (JP); Tomoyuki Koketsu, Asaka-shi (JP); Tomoyoshi Kuroishi, Niiza-shi (JP)

Correspondence Address: LAHIVE & COCKFIELD, LLP, ONE POST OFFICE SQUARE, BOSTON, MA, 02109-2127, US

(73) Assignee: Honda Motor Co., Ltd., Tokyo (JP)

(21) Appl. No.: 11/473,780

(22) Filed: Jun. 23, 2006

(30) Foreign Application Priority Data
Jun. 24, 2005 (JP) 2005-185392
Jun. 24, 2005 (JP) 2005-185407
Jun. 24, 2005 (JP) 2005-185456
Jun. 24, 2005 (JP) 2005-185467

(51) Int. Cl. H01M 8/02; H01M 8/10

(52) U.S. Cl. 429/38; 429/39; 429/30; 429/32; 429/35

(57) ABSTRACT

A fuel cell includes electrolyte electrode assemblies and a pair of separators sandwiching the electrolyte electrode assemblies. The separator includes a plurality of circular disks, and a plurality of protrusions forming a fuel gas channel for supplying a fuel gas along an electrode surface of an anode are provided on a surface of each of the circular disks. Further, a deformable electrically conductive mesh member is provided on a surface of the circular disk. The deformable elastically conductive mesh member forms an oxygen-containing gas channel for supplying an oxygen-containing gas along a cathode, and tightly contacts the cathode.

### BACKGROUND OF THE INVENTION

1. Field of the Invention

The present invention relates to a fuel cell formed by stacking an electrolyte electrode assembly and a separator. The electrolyte electrode assembly includes an anode, a cathode, and an electrolyte interposed between the anode and the cathode.

2. Description of the Related Art

Typically, a solid oxide fuel cell (SOFC) employs an electrolyte of ion-conductive solid oxide such as stabilized zirconia. The electrolyte is interposed between an anode and a cathode to form an electrolyte electrode assembly (unit cell). The electrolyte electrode assembly is interposed between separators (bipolar plates). In use, generally, a predetermined number of the unit cells and the separators are stacked together to form a fuel cell stack.

As the solid oxide fuel cell of this type, for example, a flat plate type solid oxide fuel cell adopting an internal manifold system as disclosed in Japanese Laid-Open Patent Publication No. 10-79258 is known. As shown in FIG. 84, the fuel cell has a unit cell including a fuel electrode 2, an air electrode 3, and a solid electrolyte layer 1 interposed between the fuel electrode 2 and the air electrode 3. Spacers 5 are provided on both sides of the unit cell, and separators 4 are stacked on the outside the spacers 5. A current collector 6 having low elasticity is provided on the fuel electrode 2.

In the separator 4, expansions 7 forming an oxygen-containing gas channel protrude from a gas seal surface 8 between the separator 4 and the spacer 5. The total thickness of protrusions 9 thereof and the air electrode 3 is larger than the thickness of the spacer 5.

According to the disclosure, in the structure, since the solid electrolyte layer 1 is curved toward the fuel electrode 2 by the thickness difference, even if the current collector 6 is compressed under pressure, the air electrode 3 and the separator 4 can contact each other tightly, and the tightness is maintained.

However, in the conventional technique, since the solid electrolyte layer 1 is forcibly curved toward the fuel electrode 2 by the expansions 7 provided on the separator 4, distortion occurs easily in the solid electrolyte layer 1, and the durability of the solid electrolyte layer 1 is low.

Further, in the case of an MEA of low strength having the thin solid electrolyte layer 1 and the thin air electrode 3, the air electrode 3 is damaged easily, and the MEA cannot be used effectively. In the case of an MEA having the thin fuel electrode 2 and the thin air electrode 3, the fuel electrode 2 and the air electrode 3 are damaged easily, and the MEA cannot be used effectively. Further, It is likely that an exhaust gas as the mixture of the fuel gas and the oxygen-containing gas after consumption is discharged from the outer region of the solid electrolyte layer 1 to the outside. At this time, the flow rate of the supplied air as the oxygen-containing gas is larger than the flow rate of the fuel gas. Therefore, oxygen remaining in the exhaust gas tends to flow around to the fuel electrode 2.

Thus, the outer region of the fuel electrode 2 is oxidized easily, and the effective surface area of the fuel electrode 2 becomes small in comparison with the effective surface area of the air electrode 3. Consequently, the electromotive force obtained by power generation becomes small, and the utilization ratio of the fuel gas is lowered uneconomically.

### SUMMARY OF THE INVENTION

A general object of the present invention is to provide a fuel cell having simple structure in which the damage of an electrolyte electrode assembly is prevented effectively, and electricity is collected desirably.

Further, a main object of the present invention is to provide a fuel cell in which it is possible to avoid the influence by an exhaust gas, and the fuel utilization ratio is increased.

The present invention relates to a fuel cell including an electrolyte electrode assembly and a pair of separators sandwiching the electrolyte electrode assembly. The electrolyte electrode assembly includes an anode, a cathode, and an electrolyte interposed between the anode and the cathode. Each of the separators comprises a single plate.

According to an aspect of the present invention, the fuel cell comprises protrusions provided on one surface of the separator to form a fuel gas channel for supplying a fuel gas along an electrode surface of the anode, a deformable elastic channel member provided on the other surface of the separator to form an oxygen-containing gas channel for supplying an oxygen-containing gas along an electrode surface of the cathode, and a channel member provided on the one surface or the other surface of the separator to form a fuel gas supply channel connected to a fuel gas supply unit and a fuel gas inlet for supplying a fuel gas to the fuel gas channel. The deformable elastic channel member tightly contacts the cathode. Preferably, the surface area of the cathode is smaller than the surface area of the anode.

Further, according to another aspect of the present invention, the fuel cell comprises protrusions provided on one surface of the separator to form an oxygen-containing gas channel for supplying an oxygen-containing gas along an electrode surface of the cathode, a deformable elastic channel member provided on the other surface of the separator to form a fuel gas channel for supplying a fuel gas along an electrode surface of the anode, and a channel member provided on the one surface or the other surface of the separator to form a fuel gas supply channel connected to a fuel gas supply unit and a fuel gas inlet for supplying a fuel gas to the fuel gas channel. The deformable elastic channel member tightly contacts the anode.

Further, according to still another aspect of the present invention, the fuel cell comprises a first deformable elastic channel member provided on one surface of the separator to form a fuel gas channel for supplying a fuel gas along an electrode surface of the anode, a second deformable elastic channel member provided on the other surface of the separator to form an oxygen-containing gas channel for supplying an oxygen-containing gas along an electrode surface of the cathode, and a channel member provided on the one surface or the other surface of the separator to form a fuel gas supply channel connected to a fuel gas supply unit and a fuel gas inlet for supplying a fuel gas to the fuel gas channel. The first deformable elastic channel member tightly contacts the anode, and the second deformable elastic channel member tightly contacts the cathode.

According to the present invention, in a state where the electrolyte electrode assembly is sandwiched between the protrusions and the elastic channel member, the elastic channel member is deformed elastically. Therefore, the elastic channel member tightly contacts the cathode. In the structure, the dimensional errors or distortions that occur at the time of production in the electrolyte electrode assembly or the separator can suitably be absorbed. The damage at the time of stacking the components of the fuel cell is prevented. Since the elastic channel member and the cathode contact at many points, improvement in the performance of collecting electricity is achieved.

The load in the stacking direction is efficiently transmitted through the protrusions. Therefore, the fuel cells can be stacked together with a small load, and distortion in the electrolyte electrode assemblies and the separators is reduced. In particular, even in the case of using the electrolyte electrode assembly with small strength, having the thin electrolyte and the thin cathode, the stress applied to the electrolyte and the cathode by the elastic channel member is relaxed suitably, and reduction in the damage is achieved advantageously.

Further, since the surface area of the cathode is smaller than the surface area of the anode, even if the oxygen in the exhaust gas discharged from the outer region of the electrolyte electrode assembly to the outside flows around to the anode, and the outer region of the anode is oxidized, the potential in the cathode does not change. Thus, unnecessary flow of the current such as backflow of the current is prevented, and a high electromotive force can be collected easily. Further, consumption of the fuel gas due to the unnecessary flow of the current is suppressed, and the fuel utilization ratio is increased (fuel economy is improved).

Further, according to the present invention, in a state where the electrolyte electrode assembly is sandwiched between the protrusions and the elastic channel member, the elastic channel member is deformed elastically. Therefore, the elastic channel member tightly contacts the anode. In the structure, the dimensional errors or distortions that occur at the time of production in the electrolyte electrode assembly or the separator can suitably be absorbed. The damage at the time of stacking the components of the fuel cell is prevented. Since the elastic channel member and the anode contact at many points, improvement in the performance of collecting electricity is achieved.

The load in the stacking direction is efficiently transmitted through the protrusions. Therefore, the fuel cells can be stacked together with a small load, and distortion in the electrolyte electrode assemblies and the separators is reduced. In particular, even if the anode is thin in comparison with the electrolyte, the stress applied to the anode by the elastic channel member is relaxed suitably. Further, the fuel gas is diffused suitably inside the elastic channel member. The fuel gas is distributed uniformly to the anode, and the stable and suitable power generation is achieved.

Further, according to the present invention, in a state where the electrolyte electrode assembly is sandwiched between the first and second elastic channel members, the first and second elastic channel members are deformed elastically. Therefore, the first and second channel members tightly contact the anode and the cathode. In the structure, the dimensional errors or distortions that occur at the time of production in the electrolyte electrode assembly or the separator can suitably be absorbed. The damage at the time of stacking the components of the fuel cell is prevented. Since the first and second elastic channel members and the anode and the cathode contact at many points, the load applied to the fuel cells is small, and improvement in the performance of collecting electricity is achieved.

Further, even if the anode is thin in comparison with the electrolyte, the stress applied to the anode by the first elastic channel member is relaxed suitably. Further, the fuel gas is diffused suitably inside the first elastic channel member. The fuel gas is distributed uniformly to the anode, and the stable and suitable power generation is achieved. Further, even if the cathode and the electrolyte are thin, and the strength of the electrolyte electrode assembly is small, the stress applied to the electrolyte and the cathode by the second elastic channel member is relaxed suitably. Further, the oxygen-containing gas is diffused uniformly to the cathode.

Further, no protrusions or recesses need to be formed on the surfaces of the separators facing the anode and the cathode for forming gas channels or current collectors. Thus, the shape of the separator is simplified significantly, and the separator can be produced at low cost economically.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a partial cross sectional view showing a fuel cell system according to a first embodiment of the present invention;

FIG. 2 is a perspective view schematically showing a fuel cell stack of the fuel cell system;

FIG. 3 is an exploded perspective view showing a fuel cell of the fuel cell stack;

FIG. 4 is a partial exploded perspective view showing gas flows in the fuel cell;

FIG. 5 is a front view showing a separator;

FIG. 6 is a cross sectional view schematically showing operation of the fuel cell;

FIG. 7 is an exploded perspective view showing a fuel cell according to a second embodiment of the present invention;

FIG. 8 is a front view showing a separator of the fuel cell;

FIG. 9 is a cross sectional view schematically showing operation of the fuel cell;

FIG. 10 is an exploded perspective view showing a fuel cell according to a third embodiment of the present invention;

FIG. 11 is a front view showing a separator of the fuel cell;

FIG. 12 is a cross sectional view schematically showing operation of the fuel cell;

FIG. 13 is an exploded perspective view showing a fuel cell according to a fourth embodiment of the present invention;

FIG. 14 is a cross sectional view schematically showing operation of the fuel cell;

FIG. 15 is a partial cross sectional view showing a fuel cell system according to a fifth embodiment of the present invention;

FIG. 16 is an exploded perspective view showing a fuel cell of the fuel cell system;

FIG. 17 is a partial exploded perspective view showing gas flows in the fuel cell;

FIG. 18 is a cross sectional view schematically showing operation of the fuel cell;

FIG. 19 is an exploded perspective view showing a fuel cell according to a sixth embodiment of the present invention;

FIG. 20 is a front view showing a separator of the fuel cell;

FIG. 21 is cross sectional view schematically showing operation of the fuel cell;

FIG. 22 is an exploded perspective view showing a fuel cell according to a seventh embodiment of the present invention;

FIG. 23 is a front view showing a separator of the fuel cell;

FIG. 24 is a cross sectional view schematically showing operation of the fuel cell;

FIG. 25 is an exploded perspective view showing a fuel cell according to an eighth embodiment of the present invention;

FIG. 26 is a cross sectional view schematically showing operation of the fuel cell;

FIG. 27 is an exploded perspective view showing a fuel cell according to a ninth embodiment of the present invention;

FIG. 28 is a front view showing a separator of the fuel cell;

FIG. 29 is a cross sectional view schematically showing operation of the fuel cell;

FIG. 30 is a cross sectional view showing an electrolyte electrode assembly used in a fuel cell according to a tenth embodiment of the present invention;

FIG. 31 is a cross sectional view schematically showing operation of the fuel cell;

FIG. 32 is a view showing an electrolyte electrode assembly according to an embodiment;

FIG. 33 is a view showing an electrolyte electrode assembly according to a comparative example;

FIG. 34 is a diagram showing an equivalent circuit of the electrolyte electrode assembly according to the embodiment;

FIG. 35 is a diagram showing an equivalent circuit of the electrolyte electrode assembly according to the comparative example;

FIG. 36 is an exploded perspective view showing a fuel cell according to an eleventh embodiment of the present invention;

FIG. 37 is a front view showing a separator of the fuel cell;

FIG. 38 is a cross sectional view schematically showing operation of the fuel cell;

FIG. 39 is an exploded perspective view showing a fuel cell according to a twelfth embodiment of the present invention;

FIG. 40 is a front view showing a separator of the fuel cell;

FIG. 41 is a cross sectional view schematically showing operation of the fuel cell;

FIG. 42 is an exploded perspective view showing a fuel cell according to a thirteenth embodiment of the present invention;

FIG. 43 is a front view showing a separator of the fuel cell;

FIG. 44 is a cross sectional view schematically showing operation of the fuel cell;

FIG. 45 is an exploded perspective view showing a fuel cell according to a fourteenth embodiment of the present invention;

FIG. 46 is a cross sectional view schematically showing operation of the fuel cell;

FIG. 47 is an exploded perspective view showing a fuel cell according to a fifteenth embodiment of the present invention;

FIG. 48 is a cross sectional view schematically showing operation of the fuel cell;

FIG. 49 is an exploded perspective view showing a fuel cell according to a sixteenth embodiment of the present invention;

FIG. 50 is a front view showing a separator of the fuel cell;

FIG. 51 is a cross sectional view schematically showing operation of the fuel cell;

FIG. 52 is an exploded perspective view showing a fuel cell according to a seventeenth embodiment of the present invention;

FIG. 53 is a front view showing a separator of the fuel cell;

FIG. 54 is a cross sectional view schematically showing operation of the fuel cell;

FIG. 55 is an exploded perspective view showing a fuel cell according to an eighteenth embodiment of the present invention;

FIG. 56 is a cross sectional view schematically showing operation of the fuel cell;

FIG. 57 is an exploded perspective view showing a fuel cell according to a nineteenth embodiment of the present invention;

FIG. 58 is a front view showing a separator of the fuel cell;

FIG. 59 is a cross sectional view schematically showing operation of the fuel cell;

FIG. 60 is an exploded perspective view showing a fuel cell according to a twentieth embodiment of the present invention;

FIG. 61 is a front view showing a separator of the fuel cell;

FIG. 62 is a cross sectional view schematically showing operation of the fuel cell;

FIG. 63 is an exploded perspective view showing a fuel cell according to a twenty-first embodiment of the present invention;

FIG. 64 is a front view showing a separator of the fuel cell;

FIG. 65 is a cross sectional view schematically showing operation of the fuel cell;

FIG. 66 is an exploded perspective view showing a fuel cell according to a twenty-second embodiment of the present invention;

FIG. 67 is a front view showing a separator of the fuel cell;

FIG. 68 is a cross sectional view schematically showing operation of the fuel cell;

FIG. 69 is an exploded perspective view showing a fuel cell according to a twenty-third embodiment of the present invention;

FIG. 70 is a cross sectional view schematically showing operation of the fuel cell;

FIG. 71 is an exploded perspective view showing a fuel cell according to a twenty-fourth embodiment of the present invention;

FIG. 72 is a cross sectional view schematically showing operation of the fuel cell;

FIG. 73 is an exploded perspective view showing a fuel cell according to a twenty-fifth embodiment of the present invention;

FIG. 74 is a front view showing a separator of the fuel cell;

FIG. 75 is a cross sectional view schematically showing operation of the fuel cell;

FIG. 76 is an exploded perspective view showing a fuel cell according to a twenty-sixth embodiment of the present invention;

FIG. 77 is a front view showing a separator of the fuel cell;

FIG. 78 is a cross sectional view schematically showing operation of the fuel cell;

FIG. 79 is an exploded perspective view showing a fuel cell according to a twenty-seventh embodiment of the present invention;

FIG. 80 is a cross sectional view schematically showing operation of the fuel cell;

FIG. 81 is an exploded perspective view showing a fuel cell according to a twenty-eighth embodiment of the present invention;

FIG. 82 is a front view showing a separator of the fuel cell;

FIG. 83 is a cross sectional view schematically showing operation of the fuel cell; and

FIG. 84 is a view showing a conventional fuel cell.

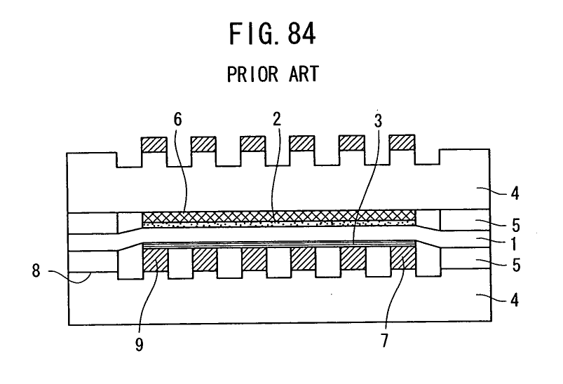

### DESCRIPTION OF THE PREFERRED EMBODIMENTS

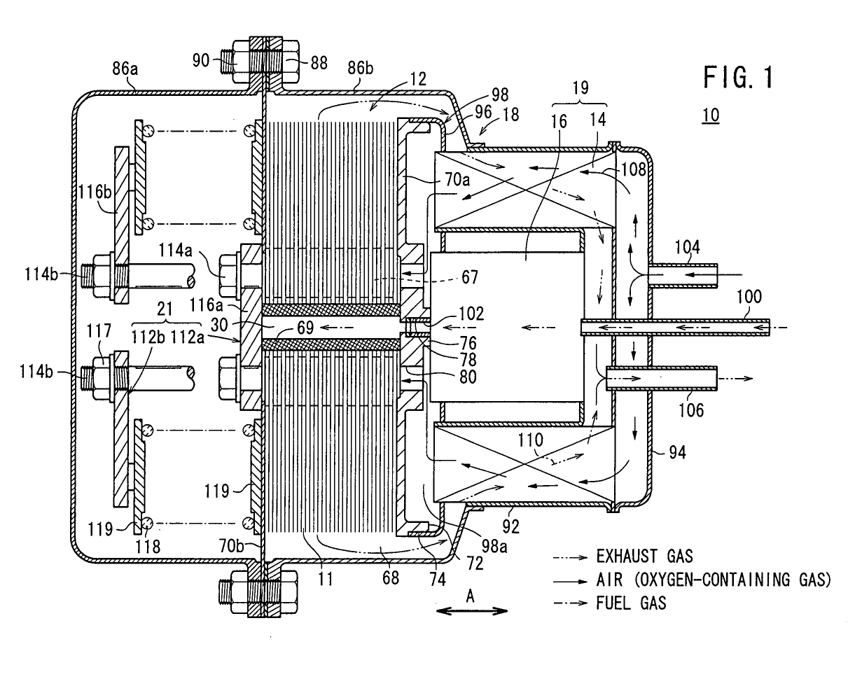

A fuel cell system 10 is used in various applications, including stationary and mobile applications. For example, the fuel cell system 10 is mounted on a vehicle. As shown in FIG. 1, the fuel cell system 10 includes a fuel cell stack 12, a heat exchanger 14, a reformer 16, and a casing 18. The fuel cell stack 12 is formed by stacking a plurality of fuel cells 11 in a direction indicated by an arrow A. The heat exchanger 14 heats an oxygen-containing gas before it is supplied to the fuel cell stack 12. The reformer 16 reforms a fuel to produce a fuel gas. The fuel cell stack 12, the heat exchanger 14, and the reformer 16 are disposed in the casing 18.

In the casing 18, a fluid unit 19 including at least the heat exchanger 14 and the reformer 16 is disposed on one side of the fuel cell stack 12, and a load applying mechanism 21 for applying a tightening load to the fuel cells 11 in the stacking direction indicated by the arrow A is disposed on the other side of the fuel cell stack 12. The fluid unit 19 and the load applying mechanism 21 are provided symmetrically with respect to the central axis of the fuel cell stack 12.

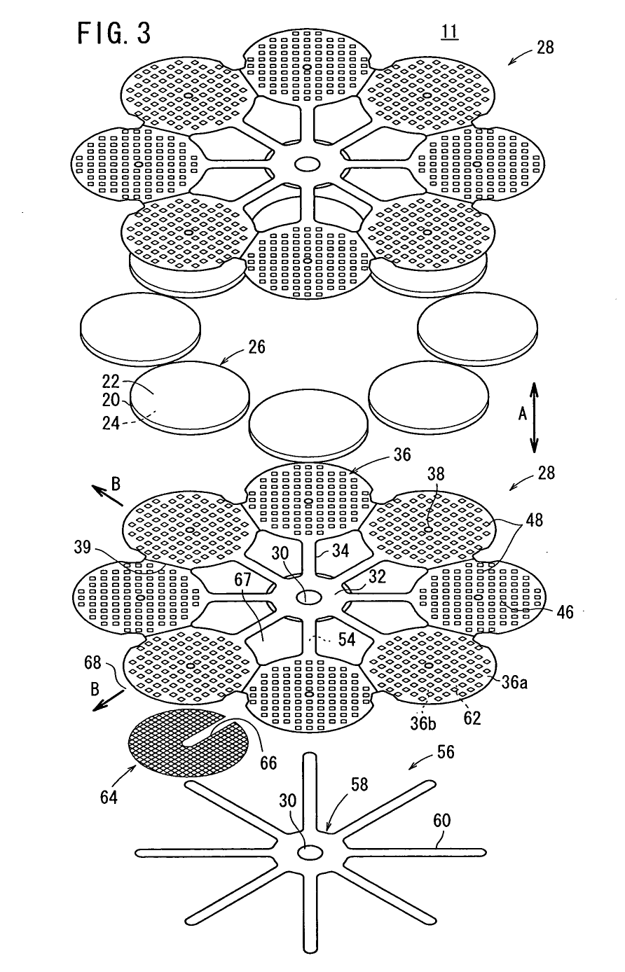

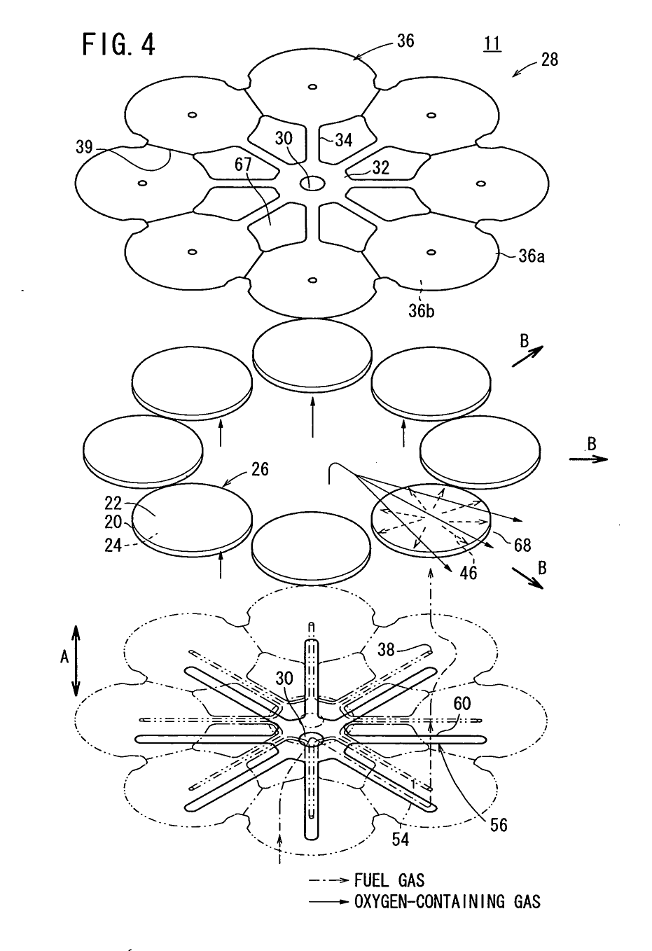

The fuel cell 11 is a solid oxide fuel cell (SOFC) and includes electrolyte electrode assemblies 26. As shown in FIGS. 3 and 4, each of the electrolyte electrode assemblies 26 includes a cathode 22, an anode 24, and an electrolyte (electrolyte plate) 20 interposed between the cathode 22 and the anode 24. For example, the electrolyte 20 is made of ion-conductive solid oxide such as stabilized zirconia. The electrolyte electrode assembly 26 has a circular disk shape. A barrier layer (not shown) is provided at least at the inner circumferential edge of the electrolyte electrode assembly 26 (central side of a separator 28) for preventing the entry of the oxygen-containing gas.

A plurality of, e.g., eight electrolyte electrode assemblies 26 are sandwiched between a pair of separators 28 to form the fuel cell 11. The eight electrolyte electrode assemblies 26 are arranged along a virtual circle concentric with a fuel gas supply passage (fuel gas supply unit) 30 extending through the central regions of the separators 28.

In FIG. 3, for example, each of the separators 28 comprises a single metal plate of, e.g., stainless alloy or a single carbon plate. The separator 28 has a first small diameter end portion 32. The fuel gas supply passage 30 extends through the central region of the first small diameter end portion 32. The first small diameter end portion 32 is integral with circular disks 36 each having a relatively large diameter through a plurality of first bridges 34. The first bridges 34 extend radially outwardly from the first small diameter end portion 32 at equal angles (intervals). The circular disk 36 and the electrolyte electrode assembly 26 have substantially the same size. A fuel gas inlet 38 for supplying the fuel gas is formed at the center of the circular plate 36, or at an upstream position deviated from the center of the circular plate 36 in the flow direction of the oxygen-containing gas.

Each of the circular disks 36 has a plurality of protrusions 48 on its surface 36a which contacts the anode 24. The protrusions 48 form a fuel gas channel 46 for supplying the fuel gas along an electrode surface of the anode 24. For example, the protrusions 48 are solid portions formed by etching on the surface 36a. Various shapes such as a square shape, a circular shape, a triangular shape, or a rectangular shape can be adopted as the cross sectional shape of the protrusions 48. The positions or the density of the protrusions 48 can be changed arbitrarily depending on the flow state of the fuel gas or the like.

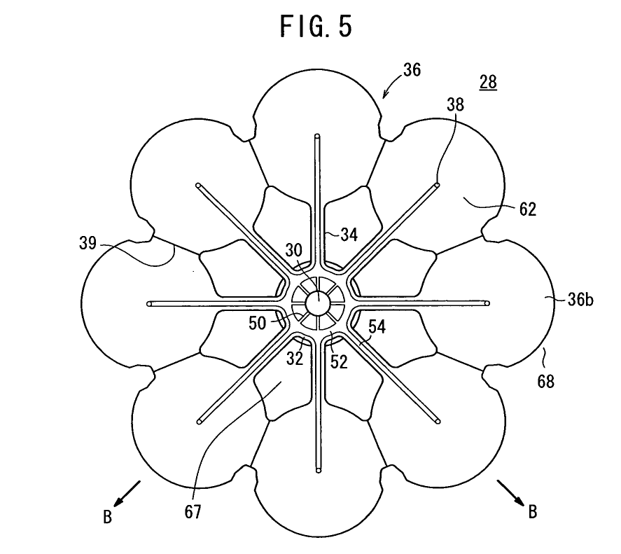

As shown in FIG. 5, each of the circular disks 36 has a substantially planar surface 36b which contacts the cathode 22. A plurality of slits 50 are radially formed in the first small diameter end portion 32. The slits 50 are connected to a recess 52. A fuel gas supply channel (groove) 54 is formed in each of the first bridges 34. The fuel gas supply channel 54 connects the fuel gas supply passage 30 to the fuel gas inlet 38 through the slit 50 and the recess 52. For example, the slit 50, the recess 52, and the fuel gas supply channel 54 are fabricated by etching.

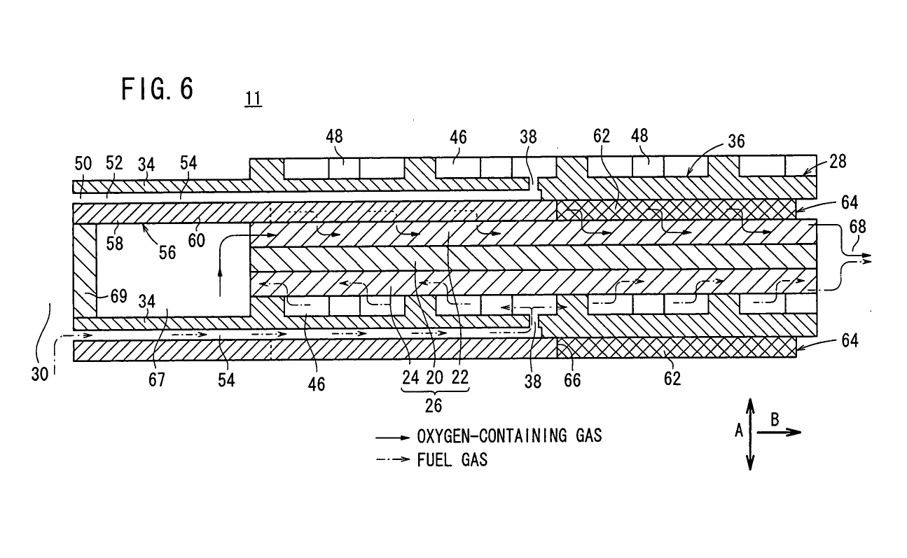

As shown in FIG. 3, a channel member 56 is fixed to a surface of the separator 28 facing the cathodes 22, e.g., by brazing or laser welding or the like. The channel member 56 is a flat plate. A second small diameter end portion 58 is formed at the central region of the channel member 56. The fuel gas supply passage 30 extends through the second small diameter end portion 58. Eight second bridges 60 extend radially from the second small diameter end portion 58. Each of the second bridges 60 is fixed to the separator 28, from the first bridge 34 to the surface 36b of the circular disk 36, covering the fuel gas inlet 38 (see FIG. 6).

As shown in FIGS. 3 and 6, a deformable elastic channel member such as an electrically conductive mesh member 64 is provided on the surface 36b of the circular disk 36. The mesh member 64 forms an oxygen-containing gas channel 62 for supplying the oxygen-containing gas along an electrode surface of the cathode 22. The mesh member 64 tightly contacts the cathode 22. For example, the mesh member 64 is made of wire rod material of stainless steel (SUS material), and has a substantially circular disk shape. The thickness of the mesh member 64 is determined such that the mesh member 64 is deformed elastically desirably when a load in the stacking direction indicated by the arrow A is applied to the mesh member 64. The mesh member 64 has a cutout 66 as a space for providing the second bridge 60 of the channel member 56.

As shown in FIG. 6, the area where the mesh member 64 is provided is smaller than the area where the protrusions 48 are provided on the surface 36a, i.e., smaller than the power generation area of the anode 24. The oxygen-containing gas channel 62 formed in the mesh member 64 is connected to an oxygen-containing gas supply unit 67. The oxygen-containing gas is supplied in the direction indicated by an arrow B through the space between the inner circumferential edge of the electrolyte electrode assembly 26 and the inner circumferential edge of the circular disk 36. The oxygen-containing gas supply unit 67 extends inside the respective circular disks 36 between the first bridges 34.

Insulating seals 69 for sealing the fuel gas supply passage 30 are provided between the separators 28. For example, the insulating seals 69 are made of mica material, or ceramic material. An exhaust gas channel 68 of the fuel cells 11 is formed outside the circular disks 36.

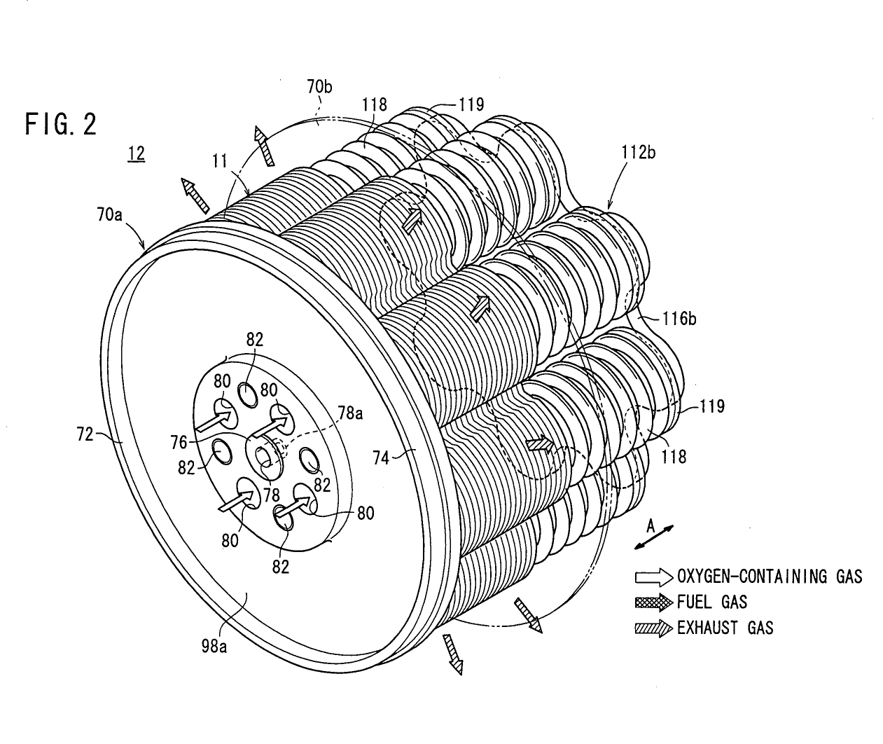

As shown in FIGS. 1 and 2, the fuel cell stack 12 includes end plates 70a, 70b provided at opposite ends of the fuel cells 11 in the stacking direction. The end plate 70a has a substantially circular disk shape. A ring shaped portion 72 protrudes from the outer circumferential end of the end plate 70a, and a groove 74 is formed around the ring shaped portion 72. A columnar convex portion 76 is formed at the central region of the ring shaped portion 72. The convex portion 76 has a projection extending in the same direction as the ring shaped portion 72. A stepped hole 78 is formed at the central region of the convex portion 76.

Holes 80 and screw holes 82 are formed in a same virtual circle around the convex portion 76. The holes 80 and the screw holes 82 are arranged alternately, and spaced at predetermined angles (intervals), at positions corresponding to the respective spaces of the oxygen-containing gas supply unit 67 formed between the first and second bridges 34, 60. The diameter of the end plate 70b is larger than the diameter of the end plate 70a. The end plate 70a is an electrically conductive thin plate.

The casing 18 includes a first case unit 86a containing the load applying mechanism 21 and a second case unit 86b containing the fuel cell stack 12. The end plate 70b and an insulating member are sandwiched between the first case unit 86a and the second case unit 86b. The insulating member is provided on the side of the second case unit 86b. The joint portion between the first case unit 86a and the second case unit 86b is tightened by screws 88 and nuts 90. The end plate 70b functions as a gas barrier for preventing entry of the hot exhaust gas or the hot air from the fluid unit 19 into the load applying mechanism 21.

An end of a ring shaped wall plate 92 is joined to the second case unit 86b, and a head plate 94 is fixed to the other end of the wall plate 92. The fluid unit 19 is provided symmetrically with respect to the central axis of the fuel cell stack 12. Specifically, the substantially cylindrical reformer 16 is provided coaxially inside the substantially ring shaped heat exchanger 14.

A wall plate 96 is fixed to the groove 74 around the end plate 70a to form a channel member 98. The heat exchanger 14 and the reformer 16 are directly connected to the chamber member 98. A chamber 98a is formed in the channel member 98, and the air heated at the heat exchanger 14 is temporally filled in the chamber 98a. The holes 80 are openings for supplying the air temporally filled in the chamber 98a to the fuel cell stack 12.

A fuel gas supply pipe 100 and a reformed gas supply pipe 102 are connected to the reformer 16. The fuel gas supply pipe 100 extends to the outside through the head plate 94. The reformed gas supply pipe 102 is inserted into the stepped hole 78 of the end plate 70a, and connected to the fuel gas supply passage 30.

An air supply pipe 104 and an exhaust gas pipe 106 are connected to the head plate 94. A channel 108 extending from the air supply pipe 104, and directly opened to the channel member 98 through the heat exchanger 14, and a channel 110 extending from the exhaust gas channel 68 of the fuel cell stack 12 to the exhaust gas pipe 106 through the heat exchanger 14 are provided in the casing 18.

The load applying mechanism 21 includes a first tightening unit 112a for applying a first tightening load T1 to a region around the fuel gas supply passage 30 and a second tightening unit 112b for applying a second tightening load T2 to the electrolyte electrode assemblies 26. The second tightening load T2 is smaller than the first tightening load T1 (T1>T2).

The first tightening unit 112a includes short first tightening bolts 114a screwed into the screw holes 82 formed along one diagonal line of the end plate 70a. The first tightening bolts 114a extend in the stacking direction of the fuel cells 11, and engage a first presser plate 116a. The first tightening bolts 114a are provided in the oxygen-containing gas supply unit 67 extending through the separators 28. The first presser plate 116a is a narrow plate, and engages the central position of the separator 28 to cover the fuel gas supply passage 30.

The second tightening unit 112b includes long second tightening bolts 114b screwed into screw holes 82 formed along the other diagonal line of the end plate 70a. Ends of the second tightening bolts 114b extend through a second presser plate 116b having a curved outer section. Nuts 117 are fitted to the ends of the second tightening bolts 114b. The second tightening bolts 114b are provided in the oxygen-containing gas unit 67 extending through the separators 28. Springs 118 and spring seats 119 are provided in respective circular portions of the second presser plate 116b, at positions corresponding to the electrolyte electrode assemblies 26 on the circular disks 36 of the fuel cell 11. For example, the springs 118 are ceramics springs.

Next, operation of the fuel cell system 10 will be described below.

As shown in FIG. 1, in the fuel cell system 10, a fuel (methane, ethane, propane, or the like) and, as necessary, water are supplied from the fuel gas supply pipe 100, and an oxygen-containing gas (hereinafter also referred to as the “air”) is supplied from the air supply pipe 104.

The fuel is reformed when it passes through the reformer 16 to produce a fuel gas (hydrogen-containing gas). The fuel gas is supplied to the fuel gas supply passage 30 of the fuel cell stack 12. The fuel gas moves in the stacking direction indicated by the arrow A, and flows into the fuel gas supply channel 54 through the slits 50 and the recess 52 in the separator 28 of each fuel cell 11 (see FIG. 6).

The fuel gas flows along the fuel gas supply channel 54 between the first and second bridges 34, 60, and flows into the fuel gas inlets 38 of the circular disks 36. Thus, the fuel gas is supplied to the fuel gas channel 46 on each of the circular disks 36. The fuel gas inlets 38 are formed at positions corresponding to substantially the central positions of the anodes 24 of the electrolyte electrode assemblies 26. Thus, the fuel gas is supplied from the fuel gas inlets 38 to substantially the central regions of the anodes 24, and flows outwardly from the central regions of the anodes 24. The fuel gas flows along the fuel gas channel 46 on each of the circular disks 36.

As shown in FIG. 1, the air from the air supply pipe 104 flows through the channel 108 of the heat exchanger 14, and temporarily flows into the chamber 98a. The air flows through the holes 80 connected to the chamber 98a, and is supplied to the oxygen-containing gas supply unit 67 provided at substantially the center of the fuel cells 11. At this time, in the heat exchanger 14, as described later, since the exhaust gas discharged to the exhaust gas channel 68 flows through the channel 110, heat exchange between the air before supplied to the fuel cells 11 and the exhaust gas is performed. Therefore, the air is heated to a desired fuel cell operating temperature beforehand.

The oxygen-containing gas supplied to the oxygen-containing gas supply unit 67 flows into the space between the inner circumferential edge of the electrolyte electrode assembly 26 and the inner circumferential edge of the circular disk 36 in the direction indicated by the arrow B, and flows toward the oxygen-containing gas channel 62 formed by the mesh member 64. As shown in FIG. 6, in the oxygen-containing gas channel 62, the oxygen-containing gas flows from the inner circumferential edge (central region of the separator 28) to the outer circumferential edge (outer region of the separator 28) of the cathode 22 of the electrolyte electrode assembly 26.

Thus, in the electrolyte electrode assembly 26, the fuel gas flows from the central region to the outer circumferential region of the anode 24, and the oxygen-containing gas flows in one direction indicted by the arrow B along the electrode surface of the cathode 22. At this time, oxygen ions flow through the electrolyte 20 toward the anode 24 for generating electricity by electrochemical reactions.

The exhaust gas discharged to the outside of the respective electrolyte electrode assemblies 26 flows through the exhaust gas channel 68 in the stacking direction. When the exhaust gas flows through the channel 110 of the heat exchanger 14, heat exchange between the exhaust gas and the air is carried out. Then, the exhaust gas is discharged through the exhaust gas pipe 106.

In the first embodiment, as shown in FIG. 6, the anode 24 of the electrolyte electrode assembly 26 contacts the protrusions 48 on the circular disk 36. The cathode 22 of the electrolyte electrode assembly 26 contacts the mesh member 64. In this state, the load in the stacking direction indicated by the arrow A is applied to the components of the fuel cell 11. Since the mesh member 64 is deformable, the mesh member 64 tightly contacts the cathode 22.

In the structure, the dimensional errors or distortions that occur at the time of production in the electrolyte electrode assembly 26 or the separator 28 can suitably be absorbed by elastic deformation of the mesh member 64. Thus, in the first embodiment, damage at the time of stacking the components of the fuel cell 11 is prevented. Since the mesh member 64 contacts the cathode 22 at many points, improvement in the performance of collecting electricity from the fuel cell 11 is achieved.

The load in the stacking direction is efficiently transmitted through the protrusions 48 on the circular disk 36. Therefore, the fuel cells 11 can be stacked together with a small load, and distortion in the electrolyte electrode assemblies 26 and the separators 28 is reduced. In particular, even in the case of using the electrolyte electrode assembly 26 (so called anode supported cell type MEA) with small strength, having the thin electrolyte 20 and the thin cathode 22, the stress applied to the electrolyte 20 and the cathode 22 by the mesh member 64 is relaxed suitably, and reduction in the damage is achieved advantageously.

The protrusions 48 on the surface 36a of the circular disk 36 are formed by etching or the like as solid portions. Thus, the shape, the positions, and the density of the protrusions 48 can be changed arbitrarily and easily, e.g., depending on the flow state of the fuel gas economically, and the desired flow of the fuel gas is achieved. Further, since the protrusions 48 are formed as solid portions, the protrusions 48 are not deformed, and thus, the load is transmitted through the protrusions 48, and electricity is collected through the protrusions 48 efficiently.

Further, in the first embodiment, the fuel gas supply passage 30 is provided hermetically inside the oxygen-containing gas supply unit 67, and the fuel gas supply channel 54 is provided along the separator surface. Therefore, the fuel gas before consumption is heated by the hot oxygen-containing gas which has been heated by the heat exchange at the heat exchanger 14. Thus, improvement in the heat efficiency is achieved.

Further, the exhaust gas channel 68 is provided around the separators 28. Since the exhaust gas channel 68 is used as a heat insulating layer, heat radiation from the inside of the separators 28 is prevented. Further, the fuel gas inlet 38 is provided at the center of the circular disk 38, or provided at an upstream position deviated from the center of the circular disk 36 in the flow direction of the oxygen-containing gas. Therefore, the fuel gas supplied from the fuel gas inlet 38 is diffused radially from the center of the anode 24 suitably. Thus, the uniform reaction occurs smoothly, and the fuel utilization ratio is increased.

Further, the area where the mesh member 64 is provided is smaller than the power generation area of the anode 24 (see FIG. 6). Therefore, even if the exhaust gas flows around to the anode 24 from the outside of the electrolyte electrode assembly 26, the power generation area is not present in the outer circumferential edge of the cathode 22 opposite to the outer circumferential edge of the anode 24. Thus, fuel consumption by the circulating current does not increase significantly, and a large electromotive force can be collected easily. Accordingly, the performance of collecting electricity is improved, and the fuel utilization ratio is increased advantageously. Further, the present invention can be carried out simply by using the mesh member 64 as the elastic channel member. Thus, the structure of the present invention is simplified economically.

Further, the eight electrolyte electrode assemblies 26 are arranged along a virtual circle concentric with the center of the separator 28. Thus, the overall size of the fuel cell 11 is small, and the influence of the heat distortion can be avoided.

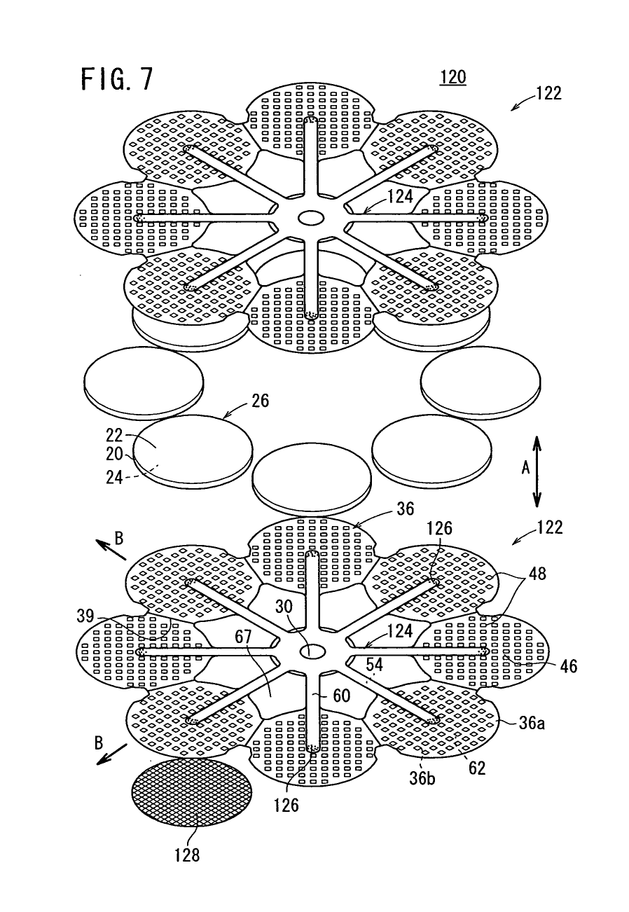

FIG. 7 is an exploded perspective view showing a fuel cell 120 according to a second embodiment of the present invention. The constituent elements that are identical to those of the fuel cell 11 according to the first embodiment are labeled with the same reference numeral, and description thereof will be omitted. Similarly, in third to twenty-eighth embodiments as described later, the constituent elements that are identical to those of the fuel cell 11 according to the first embodiment are labeled with the same reference numeral, and description thereof will be omitted.

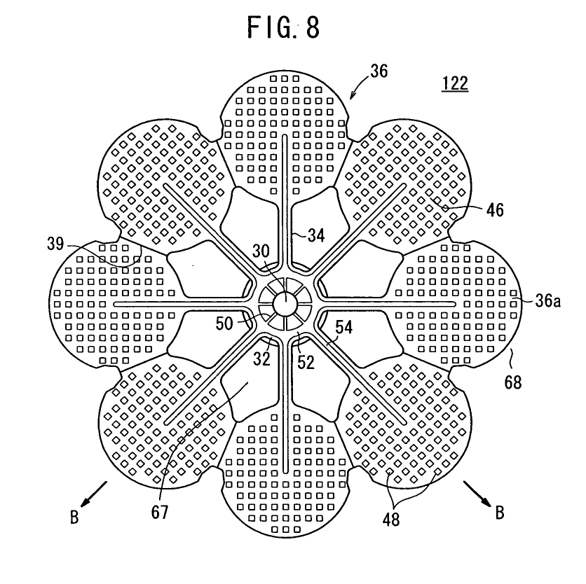

In the fuel cell 120, a channel member 124 is fixed to a surface of a separator 122 facing the anodes 24. As shown in FIG. 8, slits 50, a recess 52, and a fuel gas supply channel 54 are formed on the surface 36a of the separator 122 facing the anodes 24 by, e.g., etching.

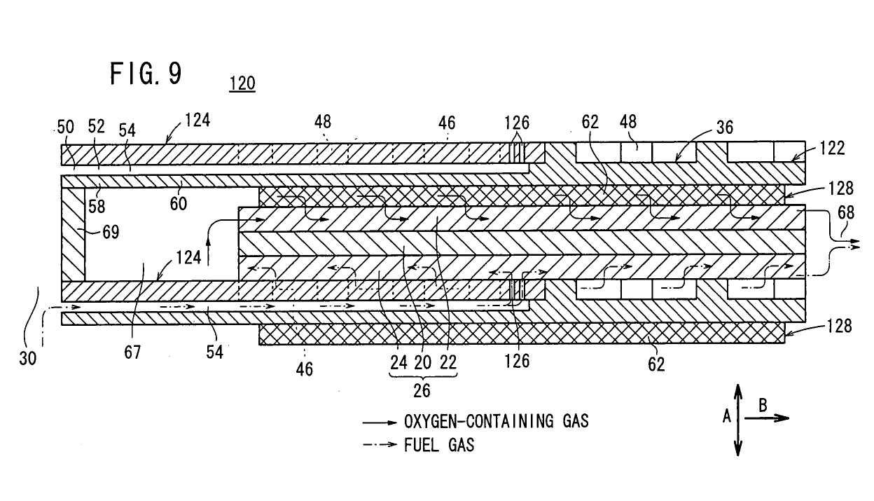

As shown in FIGS. 7 and 9, the channel member 124 has a flat shape, and a plurality of fuel gas inlets 126 are formed at each of the front ends of the second bridges 60. The fuel gas inlets 126 are opened to the anode 24. An elastic channel member such as an electrically conductive mesh member 128 is provided on the surface 36b of the circular disk 36. The mesh member 128 has a circular disk shape. The cutout 66 of the mesh member 64 is not required for the mesh member 128, and no fuel gas inlets 38 are required in the circular disks 36.

In the second embodiment, the fuel gas supplied to the fuel gas supply passage 30 flows along the fuel gas supply channel 54 formed between the separator 122 and the channel member 124. Further, the fuel gas is supplied toward the anode 24 from the fuel gas inlets 126 formed at each of the front ends of the second bridges 60.

The air flows from the oxygen-containing gas supply unit 67 to the oxygen-containing gas channel 62 formed in the mesh member 128 interposed between the cathode 22 and each of the circular disks 36. The air flows in the direction indicate by the arrow B, and is supplied to the cathode 22.

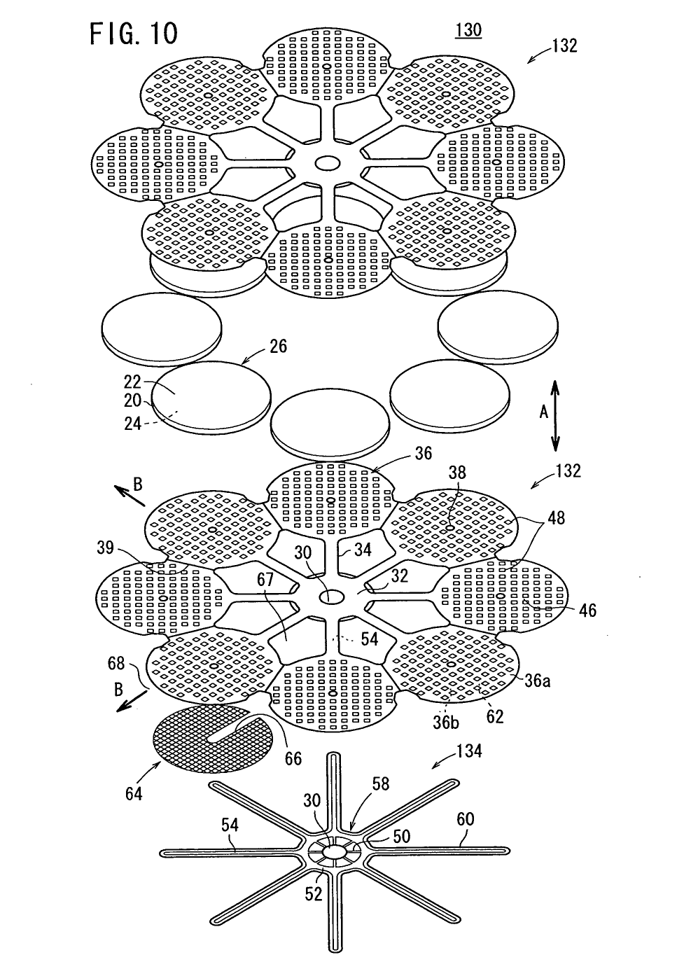

FIG. 10 is an exploded perspective view showing a fuel cell 130 according to a third embodiment of the present invention.

In the fuel cell 130, a channel member 134 is fixed to a surface of a separator 132 facing the cathode 22. The channel member 134 has a plurality of slits 50 on a surface facing the separator 132, and the slits 50 are connected to a recess 52. In each of second bridges 60, a fuel gas supply channel 54 connected to the recess 52 is formed. The slits 50, the recess 52, and the fuel gas supply channel 54 are formed by, e.g., etching. The second bridge 60 has a substantially U-shape in cross section.

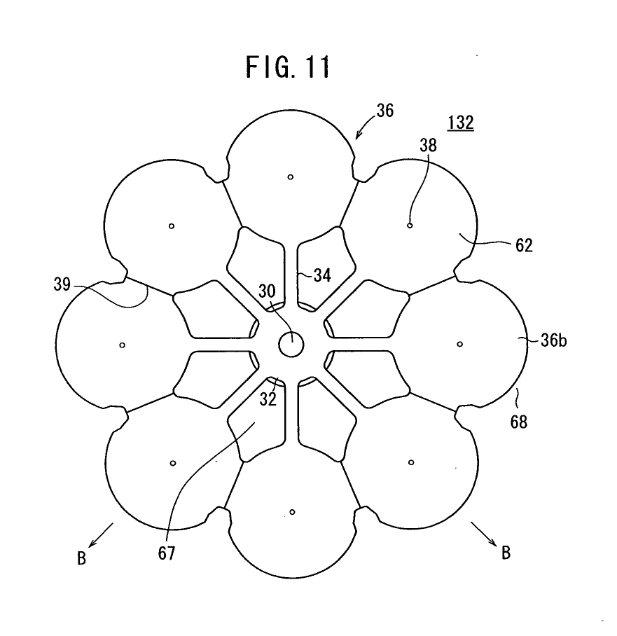

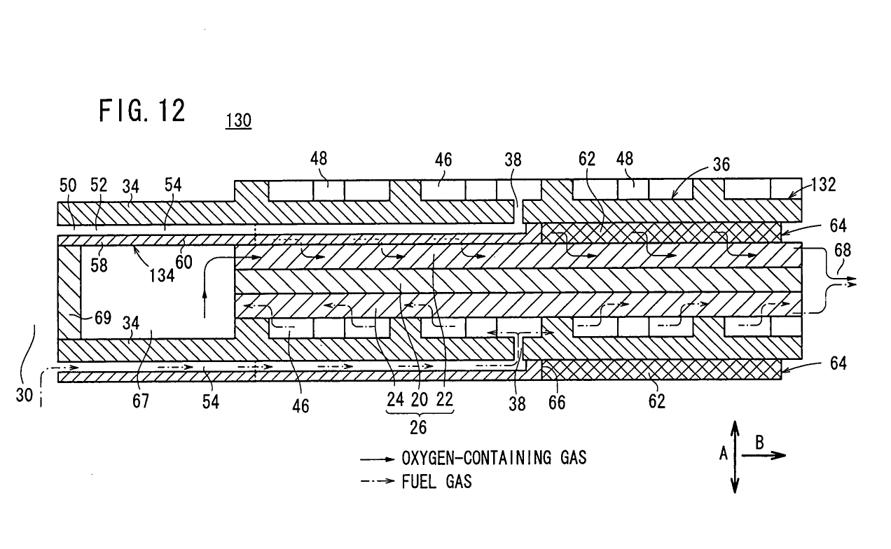

As shown in FIG. 11, the separator 132 has a planar surface 36b. The channel member 134 is fixed to the separator 132 from the first small diameter end portion 32, covering the first bridge 34 and the fuel gas inlet 38 of the circular disk 36 (see FIG. 12).

In the third embodiment, as shown in FIG. 12, the fuel gas, the oxygen-containing gas, and the exhaust gas flow in substantially the same manner as in the case of the first embodiment.

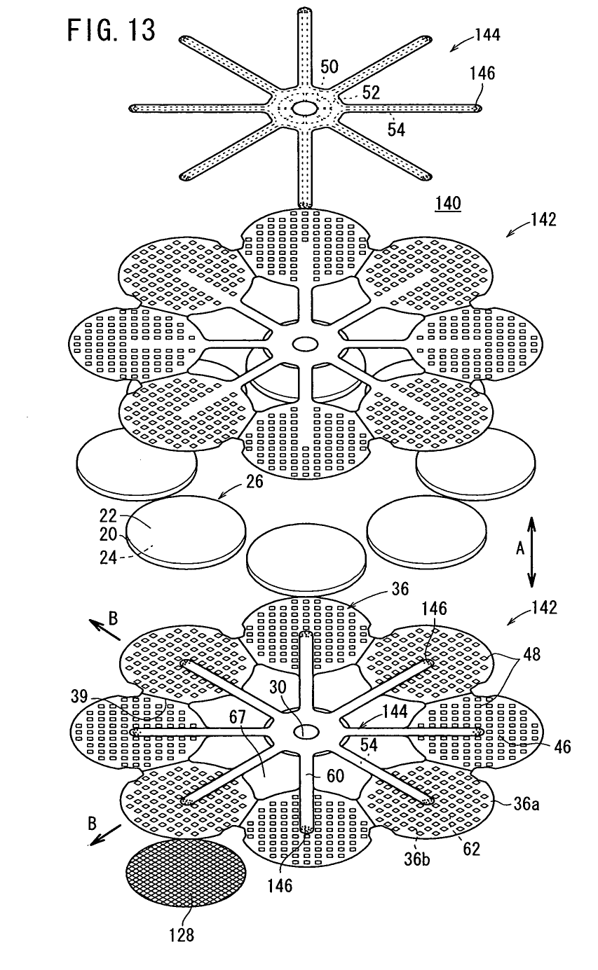

FIG. 13 is an exploded perspective view showing a fuel cell 140 according to a fourth embodiment of the present invention.

In the fuel cell 140, a channel member 144 is fixed to a surface of a separator 142 facing the anodes 24. As in the case of the channel member 134, slits 50, a recess 52, and a fuel gas supply channel 54 connected to the fuel gas supply passage 30 are formed in the channel member 144 by, e.g., etching. A plurality of fuel gas inlets 146 are formed at each of the front ends of the second bridges 60. The fuel gas inlet 146 is opened to substantially the central position of the anode 24.

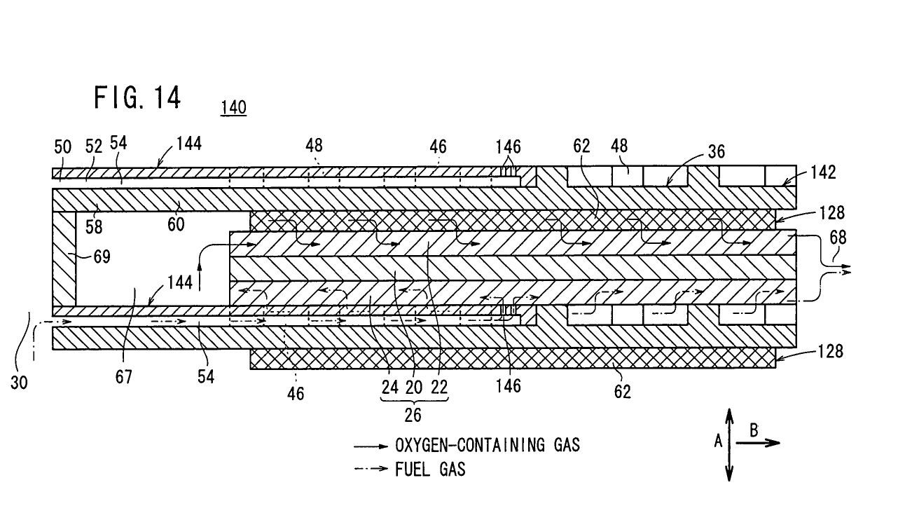

In the fourth embodiment, as shown in FIG. 14, the fuel gas, the oxygen-containing gas, and the exhaust gas flow in substantially the same manner as in the case of the second embodiment.

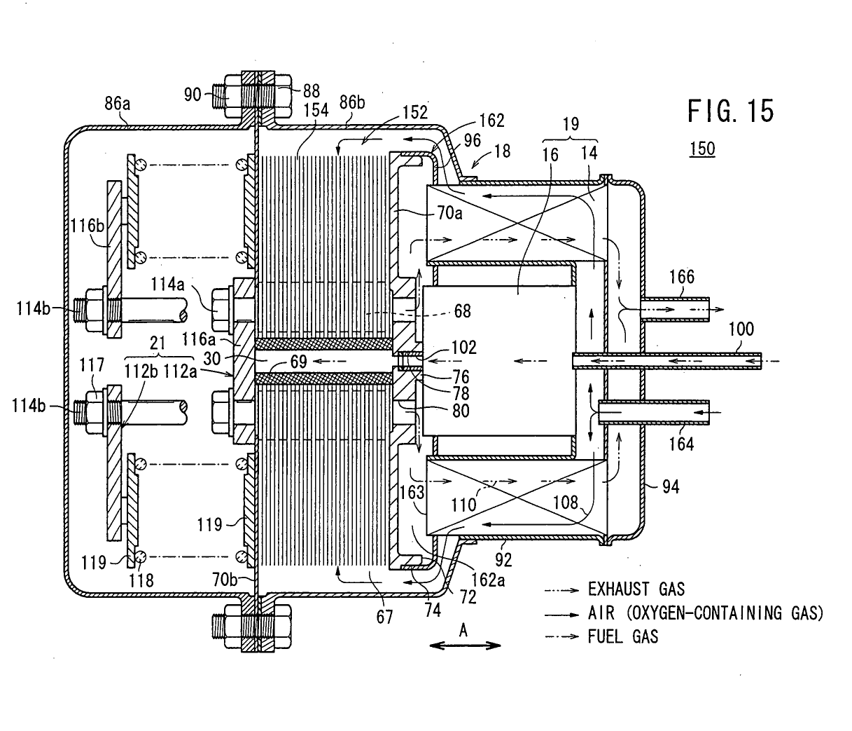

FIG. 15 is a partial cross sectional view showing a fuel cell system 150 according to a fifth embodiment of the present invention.

The fuel cell system 150 includes a fuel cell stack 152 provided in the casing 18. The fuel cell stack 152 is formed by stacking a plurality of fuel cells 154 in the direction indicated by the arrow A. The fuel cell stack 152 is sandwiched between the end plates 70a, 70b.

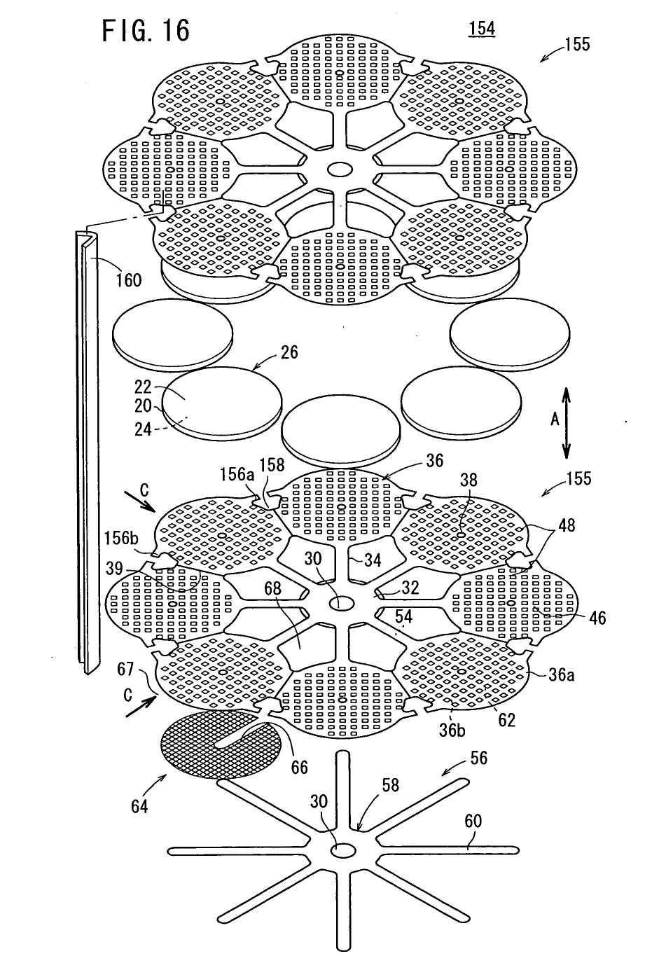

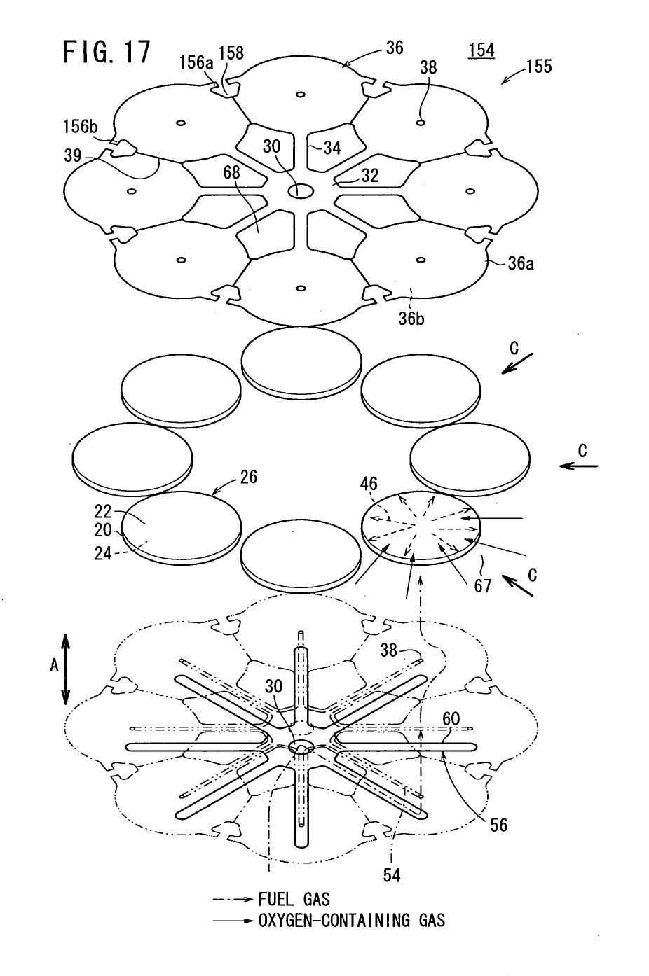

As shown in FIGS. 16 and 17, in the fuel cell 154, the oxygen-containing gas flows along the cathode 22 of the electrolyte electrode assembly 26 in the direction indicated by an arrow C from the outer circumferential edge to the inner circumferential edge of the cathode 22, i.e., in the direction opposite to the flow direction in the cases of the first to fourth embodiments.

In separators 155 of the fuel cell 154, an oxygen-containing gas supply unit 67 is provided outside the circular disks 36. An exhaust gas channel 68 is formed by spaces between the first bridges 34 inside the circular disks 36. The exhaust gas channel 68 extends in the stacking direction. Each of the circular disks 36 includes extensions 156a, 156b protruding toward the adjacent circular disks 36 on both sides, respectively. Spaces 158 are formed between the adjacent extensions 156a, 156b, and baffle plates 160 extend along the respective spaces 158 in the stacking direction.

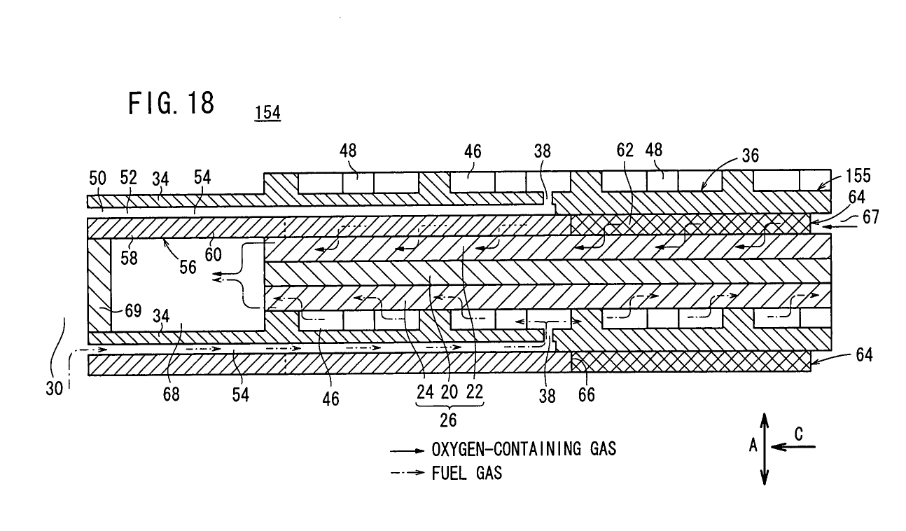

As shown in FIG. 18, the oxygen-containing gas channel 62 is connected to the oxygen-containing gas supply unit 67 for supplying the oxygen-containing gas from the space between the outer circumferential edge of the circular disk 36 and the outer circumferential edge of the electrolyte electrode assembly 26 in the direction indicated by the arrow C. The oxygen-containing gas supply unit 67 is formed around the separators 155 including the area between the extensions 156a, 156b of the circular disks 36 (see FIG. 16).

As shown in FIG. 15, a channel member 162 having a chamber 162a connected to the exhaust gas channel 68 through the holes 80 is formed at the end plate 70a. The exhaust gas discharged from the fuel cells 154 is temporarily filled in the chamber 162a. The exhaust gas flows through the channel 110 in the heat exchanger 14 through an opening 163 opened directly to the chamber 162a.

An air supply pipe 164 and an exhaust gas pipe 166 are connected to the head plate 94. The air supply pipe 164 extends up to a position near the reformer 16. An end of the exhaust gas pipe 166 is connected to the head plate 94.

In the fifth embodiment, the fuel gas flows from the fuel gas supply pipe 100 to the fuel gas supply passage 30 through the reformer 16. The air as the oxygen-containing gas flows from the air supply pipe 164 into the channel 108 of the heat exchanger 14, and is supplied to the oxygen-containing gas supply unit 67 outside the fuel cells 154. As shown in FIG. 18, the air flows from the spaces between the outer circumferential edge of the electrolyte electrode assembly 26 and the outer circumferential edge of the circular disk 36 in the direction indicated by the arrow C, and the air is supplied to the oxygen-containing gas channel 62 formed by the mesh member 64.

Thus, power generation is performed in each of the electrolyte electrode assemblies 26. The exhaust gas as the mixture of the fuel gas and the air after consumption in the reactions of the power generation flows in the stacking direction through the exhaust gas channel 68 in the separators 155. The exhaust gas flows through the holes 80, and is temporarily filled in the chamber 162a in the channel member 162 formed at the end plate 70a (see FIG. 15). Further, when the exhaust gas flows through the channel 110 of the heat exchanger 114, heat exchange is performed between the exhaust gas and the air. Then, the exhaust gas is discharged through the exhaust gas pipe 166.

In the fifth embodiment, the fuel gas supply passage 30 is provided hermetically inside the exhaust gas channel 68, and the fuel gas supply channel 54 is provided along the separator surface. Therefore, the fuel gas flowing through the fuel gas supply passage 30 before consumption is heated by the heat of the exhaust gas discharged into the exhaust gas channel 68. Thus, improvement in the heat efficiency is achieved.

Further, since the exhaust gas channel 68 extends through the central part of the separators 155, it is possible to heat the separators 155 radially from the central part by the heat of the exhaust gas, and improvement in the heat efficiency is achieved.

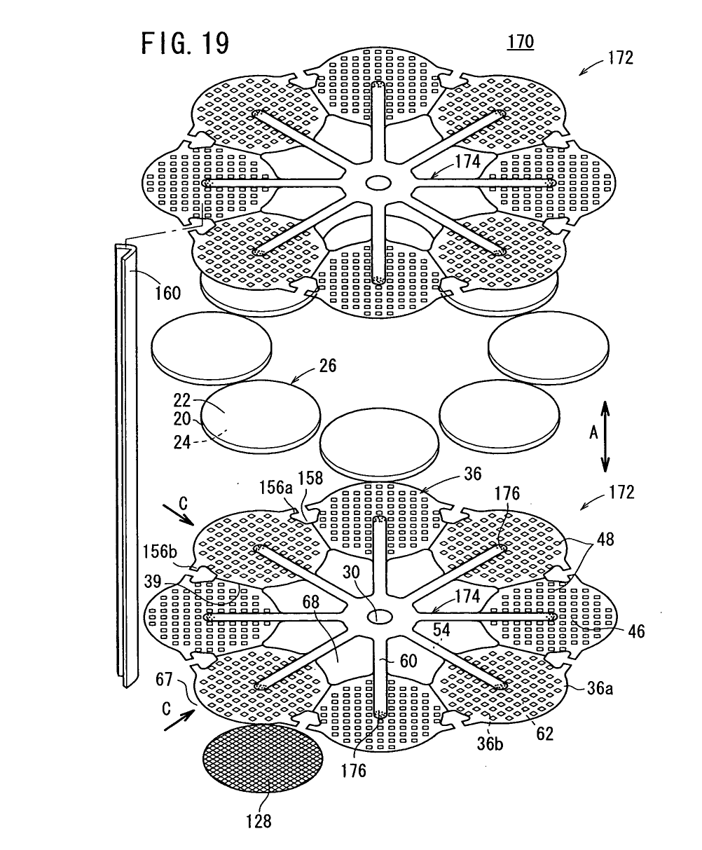

FIG. 19 is an exploded perspective view showing a fuel cell 170 according to a sixth embodiment of the present invention.

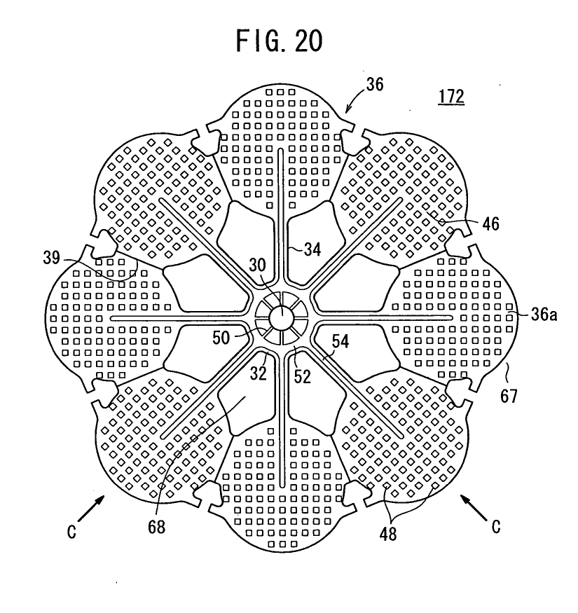

In the fuel cell 170, a channel member 174 is fixed to a surface of a separator 172 facing the anodes 24. The channel member 174 has a flat shape. A plurality of fuel gas inlets 176 are formed at each of the front ends of the second bridges 60. The fuel gas inlets 176 are opened to the anode 24. As shown in FIG. 20, slits 50, a recess 52, and a fuel gas supply channel 54 connected to the fuel gas supply passage 30 are formed on the surface 36a of the separator 172 by, e.g., etching.

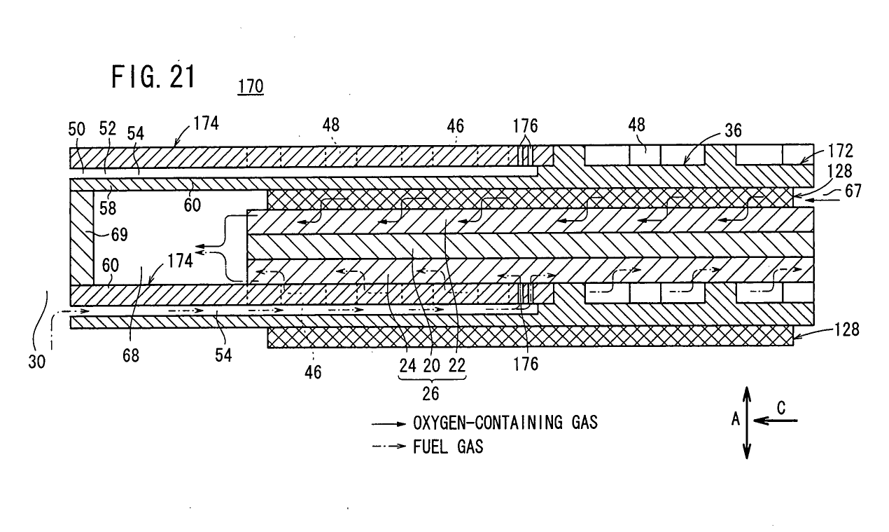

In the sixth embodiment, the oxygen-containing gas, the fuel gas, and the exhaust gas flow as shown in FIG. 21.

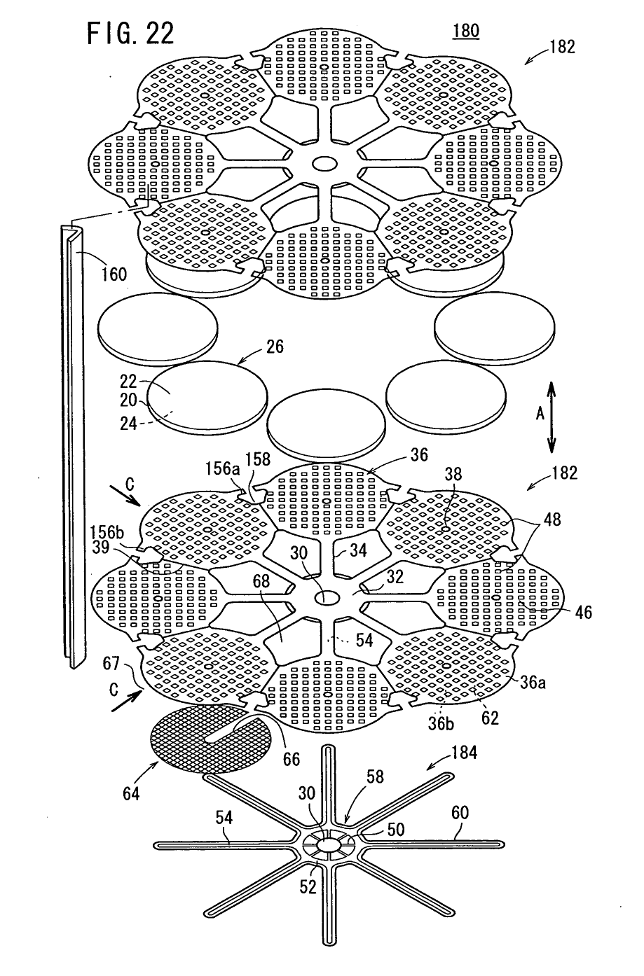

FIG. 22 is an exploded perspective view showing a fuel cell 180 according to a seventh embodiment of the present invention.

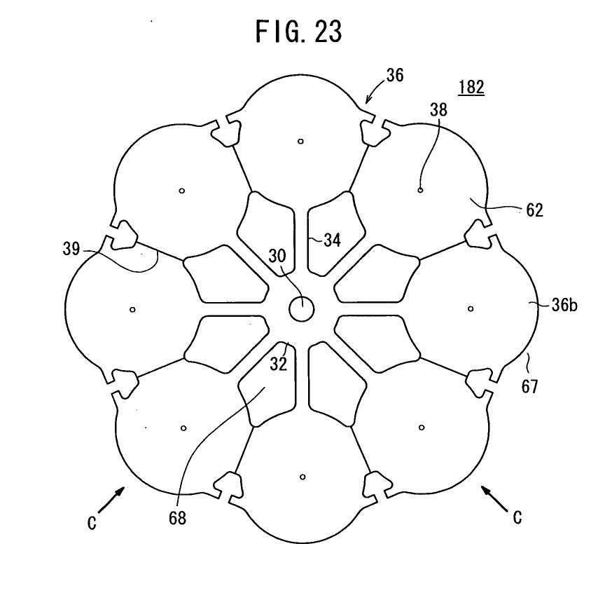

In the fuel cell 180, a channel member 184 is fixed to a surface of a separator 182 facing the cathodes 22. Slits 50, a recess 52, and a fuel gas supply channel 54 are formed in the channel member 184 by, e.g., etching. As shown in FIG. 23, the separator 182 has a planar surface 36b extending over the first small diameter end portion 32, the first bridges 34, and the circular disks 36.

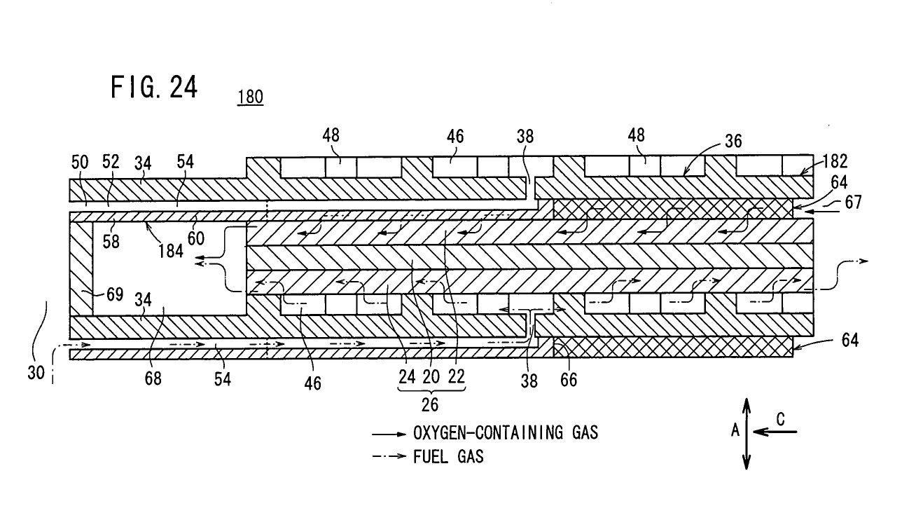

In the seventh embodiment, the oxygen-containing gas, the fuel gas, and the exhaust gas flow as shown in FIG. 24.

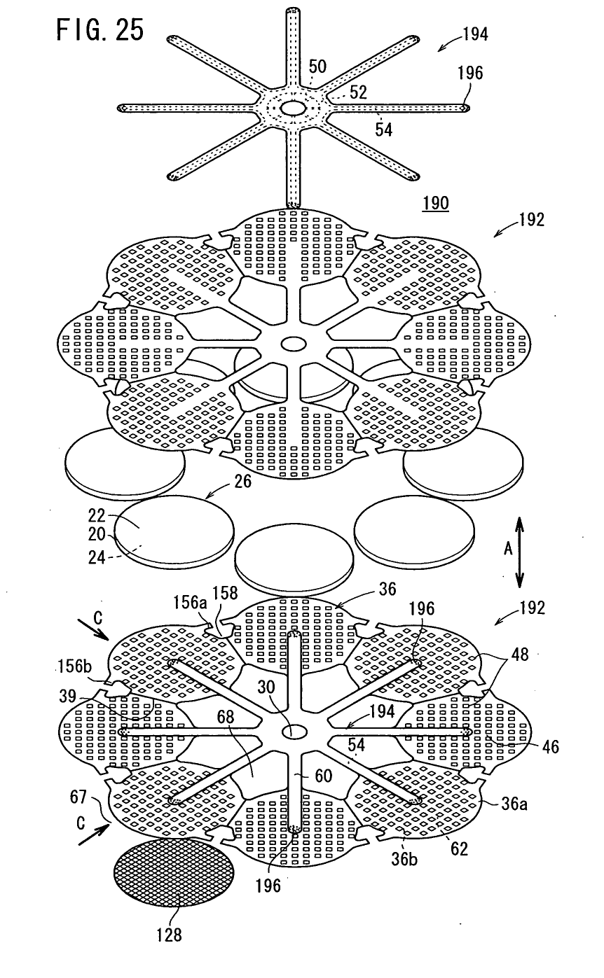

FIG. 25 is an exploded perspective view showing a fuel cell 190 according to an eighth embodiment of the present invention.

In the fuel cell 190, a channel member 194 is fixed to a surface of a separator 192 facing the anodes 24. Slits 50, a recess 52, and a fuel gas supply channel 54 are formed in the channel member 194 by, e.g., etching. A plurality of fuel gas inlets 196 are formed at each of the front ends of the second bridges 60 of the channel member 194. The fuel gas inlets 196 are opened to the anode 24.

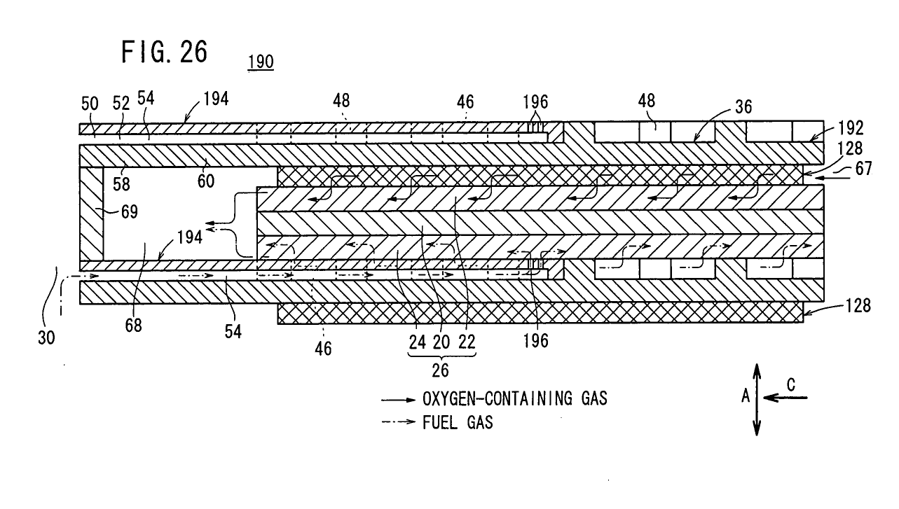

In the eighth embodiment, the oxygen-containing gas, the fuel gas, and the exhaust gas flow as shown in FIG. 26.

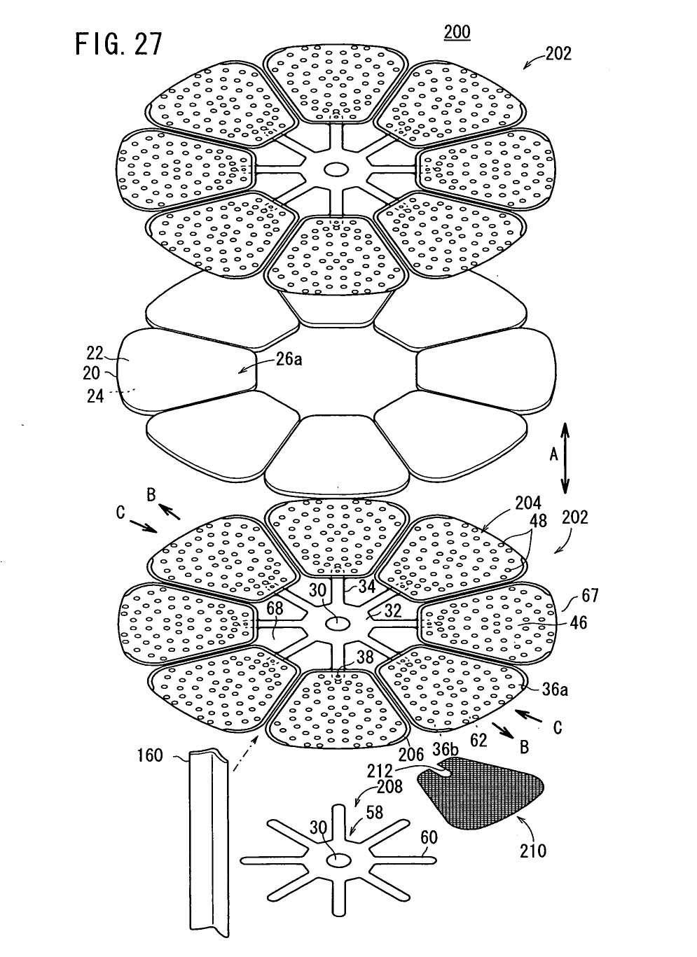

FIG. 27 is an exploded perspective view showing a fuel cell 200 according to a ninth embodiment of the present invention.

The fuel cell 200 includes electrolyte electrode assemblies 26a each having a substantially trapezoidal shape. Eight electrolyte electrode assemblies 26a are sandwiched between a pair of separators 202. The separator 202 includes trapezoidal sections 204 corresponding to the shape of the electrolyte electrode assemblies 26a. A plurality of protrusions 48 and a seal 206 are formed on a surface 36a of the trapezoidal section 204 facing the anode 24 by e.g., etching. The seal 206 is formed around the outer edge of the trapezoidal section 204, except the outer circumferential portion.

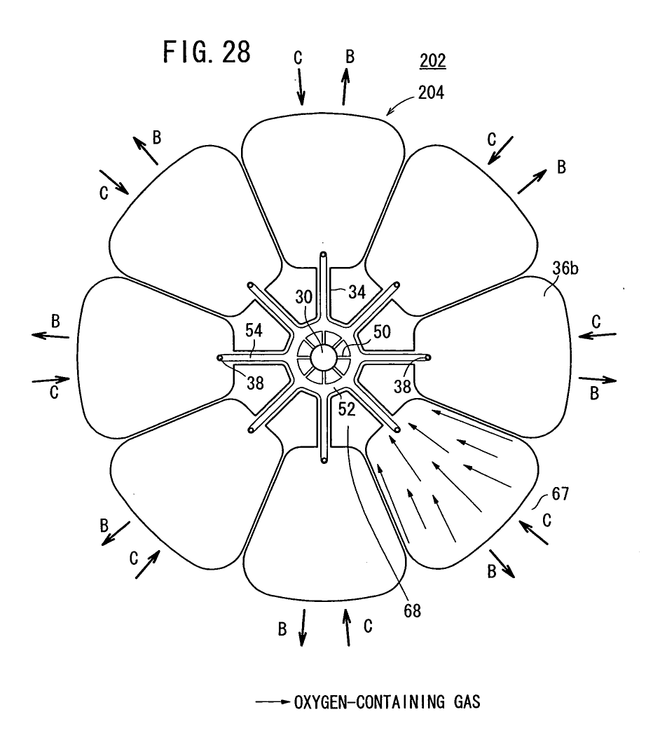

As shown in FIG. 28, slits 50, a recess 52, and a fuel gas supply channel 54 are formed on a surface 36b of the separator 202 by, e.g., etching. The fuel gas supply channel 54 is connected to fuel gas inlets 38 formed at the inner edge portions of the trapezoidal sections 204. A channel member 208 is fixed to the separator 202 to cover the slits 50, the recess 52, the fuel gas supply channel 54a, and the fuel gas inlets 38. The channel member 208 has a flat shape.

As shown in FIG. 27, a deformable elastic channel member such as an electrically conductive mesh member 210 is provided on the surface 36b of each of the trapezoidal sections 204. The mesh member 210 has a substantially trapezoidal shape, and has a cutout 212 as a space for providing the second bridge 60 of the channel member 208. The mesh member 210 has a substantially trapezoidal shape. The size of the mesh member 210 is smaller than the size of the trapezoidal section 204.

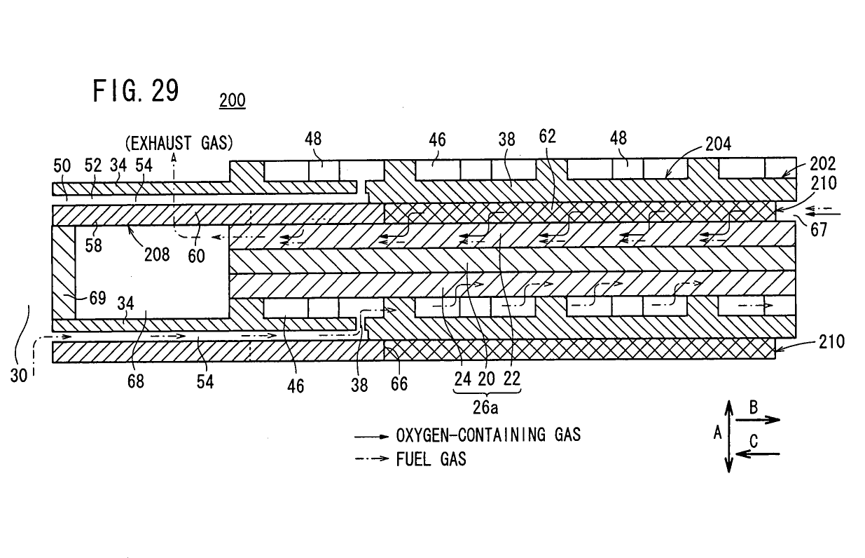

In the ninth embodiment, the fuel gas from the fuel gas supply passage 30 flows through the slits 50 and the recess 52 of the separator 202 of the fuel cell 200, and flows into the fuel gas supply channel 54. As shown in FIG. 29, the fuel gas flows through the fuel gas inlet 38 formed in the trapezoidal section 204, and is supplied to the fuel gas channel 46. Thus, the fuel gas flows outwardly in the direction indicated by the arrow B from the inner edge of the anode 24 to the outer edge along the fuel gas channel 46.

The oxygen-containing gas supplied to the oxygen-containing gas supply unit 67 provided around the fuel cell 200 flows from the space between the outer circumferential edge of the electrolyte electrode assembly 26a and the outer circumferential edge of the trapezoidal section 204 in the direction indicated by the arrow C, reaching the oxygen-containing gas channel 62 of the mesh member 210. Thus, in the electrolyte electrode assembly 26a, electrochemical reactions are induced for power generation.

The ninth embodiment substantially adopts the structure of the fifth embodiment. However, the present invention is not limited in this respect. The technical features of the ninth embodiment may be based on the structure of the sixth to eighth embodiments, or the structure of the first to fourth embodiments in which the oxygen-containing gas flows from the inside to the outside of the separators.

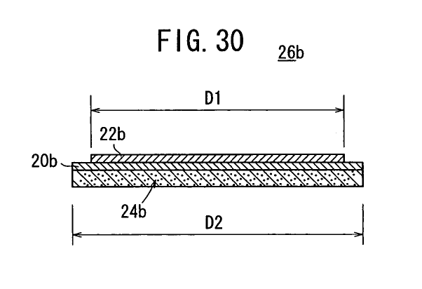

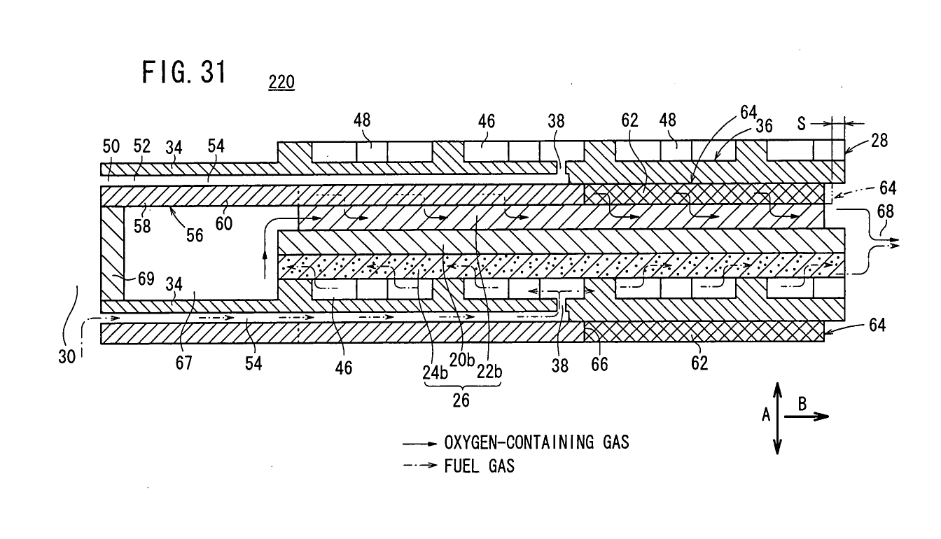

In the first to eighth embodiments, the electrolyte electrode assemblies 26 are used. Alternatively, electrolyte electrode assemblies 26b as shown in FIG. 30 may be adopted. FIG. 31 shows a fuel cell 220 including the electrolyte electrode assemblies 26b according to a tenth embodiment. The fuel cell 220 has substantially the same structure as the fuel cell 11 according to the first embodiment.

As shown in FIG. 30, the electrolyte electrode assembly 26b includes a cathode 22b, an anode 24b, and an electrolyte 20b interposed between the cathode 22b and the anode 24b. For example, the anode 24b is made of porous material of Ni. The surface area of the cathode 22b is smaller than the surface area of the anode 24b. Specifically, the diameter Dl of the cathode 22b is smaller than the diameter D2 of the anode 24b (Dl<D2).

The area corresponding to the reduction (difference) of the diameter Dl of the cathode 22b from the diameter D2 of the anode 24b is determined by the amount (distance) of the exhaust gas flowing around to the anode 24b (hereinafter referred to as the “flow-around distance”). The flow-around distance of the exhaust gas changes depending on the height of the gap between the anode 24b and the separator 28, the flow rate of the fuel gas, the flow rate of the oxygen-containing gas, and the method of supplying the oxygen-containing gas. The diameter D1 is determined by the flow-around distance.

For example, the flow-around distance of the exhaust gas is about 10 to 40 times as large as the height of the gap between the anode 24b and the separator 28. Preferably, the flow-around distance of the exhaust gas is about 15 to 30 times as large as the height of the gap between the anode 24b and the separator 28. For example, if the gap height is 50 μm, since the flow-around distance is about 0.75 to 1.5 mm, the diameter D1 of the cathode 22b should be smaller than the diameter D2 of the anode 24b by about 1.5 mm to 3.0 mm.

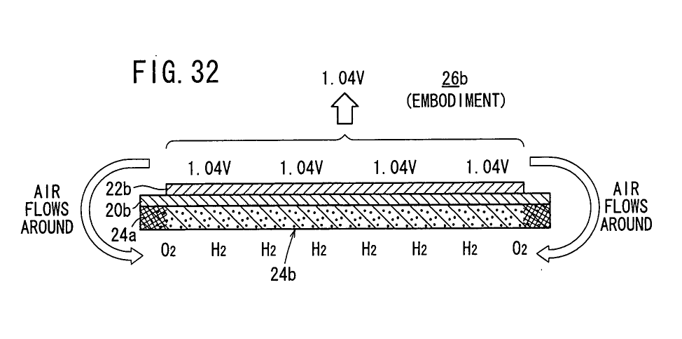

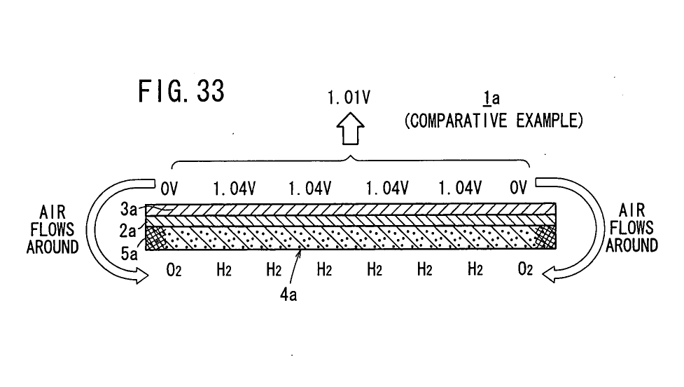

In the tenth embodiment, as shown in FIG. 30, the electrolyte electrode assembly 26b having a circular disk shape is adopted, and the diameter D1 of the cathode 22b is smaller than the diameter D2 of the anode 24b. As shown in FIGS. 32 and 33, a power generation experiment was conducted using the electrolyte electrode assembly 26b and an electrolyte electrode assembly 1a as a comparative example. The electrolyte electrode assembly 1a has a cathode 3a, an anode 4a, and an electrolyte 2a interposed between the cathode 3a and the anode 4a. The surface area of the cathode 3a and the surface area of the anode 4a are the same.

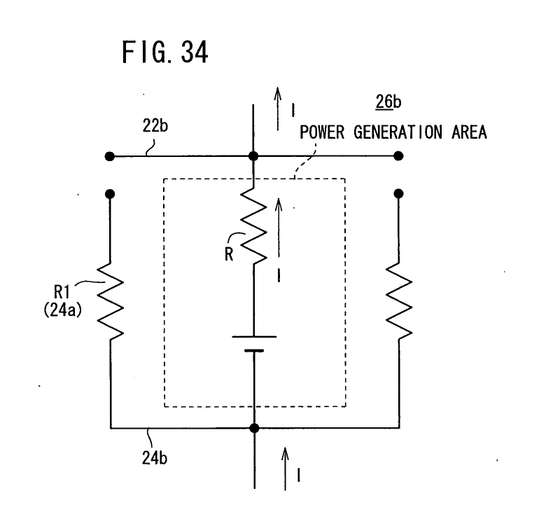

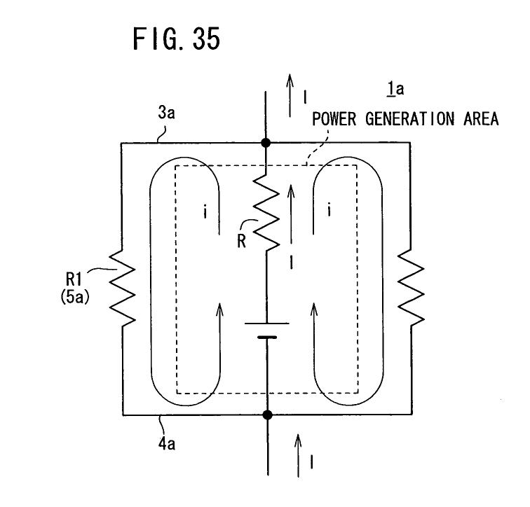

Then, power generation was performed using the electrolyte electrode assemblies 26b, 1a. In each of the electrolyte electrode assemblies 26a, 1a, the oxygen in the exhaust gas flowed from the outside of the anodes 24b, 4a, and oxidized portions 24a, 5a are formed in the outer regions of the anodes 24b, 4a. The oxidized portions 24a, 5a of the anodes 24b, 4a became electrical resistors, and functioned as resistors R1 in equivalent circuits shown in FIGS. 34 and 35. Resistors R represent overpotential, contact resistance or the like in the electrolyte electrode assemblies 26b, 1a.

In the electrolyte electrode assembly 1a shown in FIG. 33, the surface area of the cathode 3a and the surface area of the anode 4a are the same. A low potential portion (0V) is formed in the outer region of the cathode 3a, corresponding to the oxidized portion 5a of the anode 4a.

Therefore, at the central region of the electrolyte electrode assembly 1a,current flowed from the cathode 3a having a large electromotive force to the current collector (not shown), and in the outer region of the electrolyte electrode assembly 1a, current flowed from the current collector to the cathode 3a having a low electromotive force. That is, as shown in FIG. 35, circulation current i flows inside the electrolyte electrode assembly 1a. Therefore, current I+2i flows in the power generation area as a whole.

Therefore, when current I is collected to the outside, the excessive current in the amount of the circulation current i flows inside the electrolyte electrode assembly 1a. Thus, the fuel consumption was increased by the amount corresponding to the excessive current, and the fuel consumption ratio (fuel economy) was lowered significantly.

In contrast, in the case of the electrolyte electrode assembly 26b, since the surface area of the cathode 22b is smaller than the surface area of the anode 24b, the route of the circulation current was interrupted (see FIG. 34). Thus, fuel consumption by the circulating current does not increase significantly, and a large electromotive force can be collected easily. Accordingly, the fuel utilization ratio is increased (fuel economy is improved) advantageously.

Further, the electrolyte electrode assembly 26b is fabricated simply by providing the cathode 22b to have a predetermined surface area. Therefore, the fabrication cost of the electrolyte electrode assembly 26b is low economically.

The surface area of the mesh member 64 and the surface area of the cathode 22b are substantially the same. Alternatively, the surface area of the mesh member 64 is determined such that the cathode 22b can be placed inside the mesh member 64. The outer diameter of the mesh member 64 is determined such that it is not exposed to the oxygen-containing gas in the exhaust gas. Thus, even if the cathode 22b and the mesh member 64 do not match at the time of assembling the fuel cell 220, and even if there is any dimensional error of the cathode 22b, the entire cathode 22b can be placed inside the mesh member 64. Accordingly, the mesh member 64 reliably contacts the cathode 22b, and the power generation reaction occurs suitably.

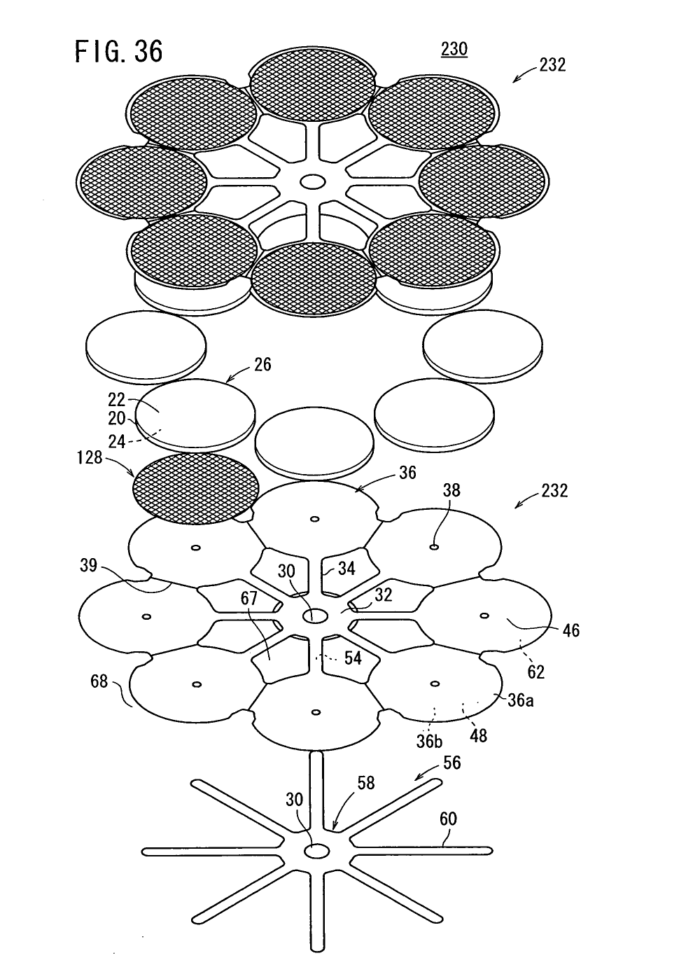

FIG. 36 is an exploded perspective view showing a fuel cell 230 according to an eleventh embodiment of the present invention. For example, the fuel cell 230 includes a separator 230 made of a single metal plate such as a plate of stainless alloy or a single carbon plate, as with the separator 28.

Each of the circular disks 36 of the separator 232 has a substantially planar surface 36a which contacts the anode 22. A deformable elastic channel member such as an electrically conductive mesh member 128 is provided on the surface 36a of the circular disk 36. The mesh member 128 forms a fuel gas channel 46 for supplying the fuel gas along an electrode surface of the anode 24. The mesh member 128 tightly contacts the anode 24.

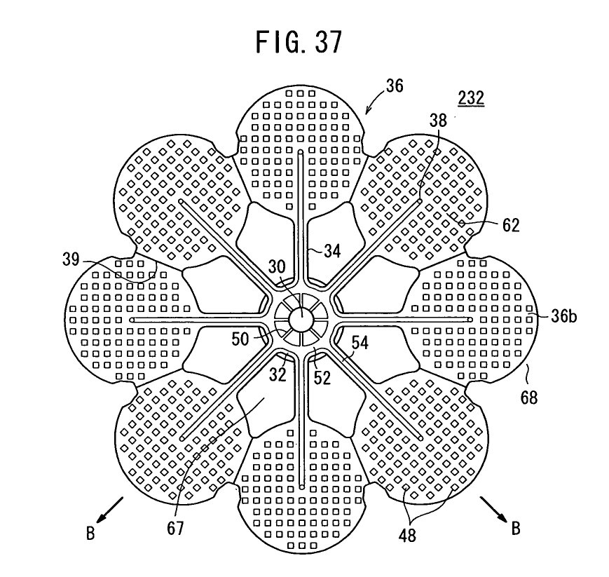

As shown in FIG. 37, each of the circular disks 36 has a plurality of protrusions on a surface 36b which contacts the cathode 22. The protrusions 48 form an oxygen-containing gas channel 62 for supplying the oxygen-containing gas along an electrode surface of the cathode 22. The protrusions 48 are solid portions formed on the surface 36b by, e.g., etching.

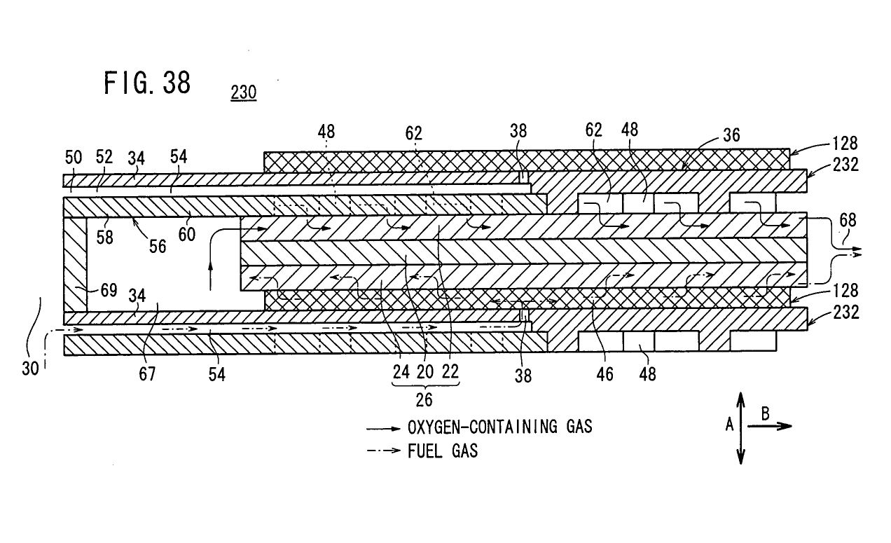

As shown in FIG. 38, the area where the mesh member 128 is provided is larger than the area where the protrusions 48 are provided on the surface 36b, i.e., lager than the power generation area of the cathode 22. The oxygen-containing gas channel 62 formed in the mesh member 128 is connected to the oxygen-containing gas supply unit 67. The oxygen-containing gas is supplied in the direction indicated by the arrow B from the space between the inner circumferential edge of the electrolyte electrode assembly 26 and the inner circumferential edge of the circular disk 36.

As shown in FIG. 38, in the eleventh embodiment, the cathode 22 of the electrolyte electrode assembly 26 contacts the protrusions 48 on the surface 36b of the circular disk 36, and the anode 24 of the electrolyte electrode assembly 26 contacts the mesh member 128. In this state, the load in the stacking direction indicated by the arrow A is applied to the components of the fuel cell 230. Since the mesh member 128 is deformable, the mesh member 128 tightly contacts the anode 24.

In the structure, the dimensional errors or distortions that occur at the time of production in the electrolyte electrode assembly 26 or the separator 232 can suitably be absorbed by elastic deformation of the mesh member 128. Thus, in the eleventh embodiment, damage at the time of stacking the components of the fuel cell 230 is prevented. Since the mesh member 128 contacts the anode 24 at many points, improvement in the performance of collecting electricity from the fuel cell 230 is achieved. In particular, even in the case of using the electrolyte electrode assembly 26 (so called electrolyte supported cell type MEA), having the structure in which the cathode 22 and the anode 24 are thin in comparison with the electrolyte 20, the stress applied to the anode 24 by the mesh member 128 is relaxed suitably, and reduction in the damage is achieved advantageously.

The fuel gas is diffused smoothly inside the mesh member 128. Thus, the fuel gas is distributed uniformly to the anode 24, and the stable and suitable power generation can be performed advantageously.

Further, the area where the mesh member 128 is provided is larger than the power generation area of the cathode 22 (see FIG. 38). Therefore, even if the exhaust gas flows around to the anode 24 from the outside of the electrolyte electrode assembly 26, the power generation area is not present in the outer circumferential edge of the cathode 22 opposite to the outer circumferential edge of the anode 24. Thus, fuel consumption by the circulating current does not increase significantly, and a large electromotive force can be collected easily. Accordingly, the performance of collecting electricity is improved, and the fuel utilization ratio is increased advantageously. Further, the present invention can be carried out simply by using the mesh member 128 as the elastic channel member. Thus, the structure of the present invention is simplified economically.

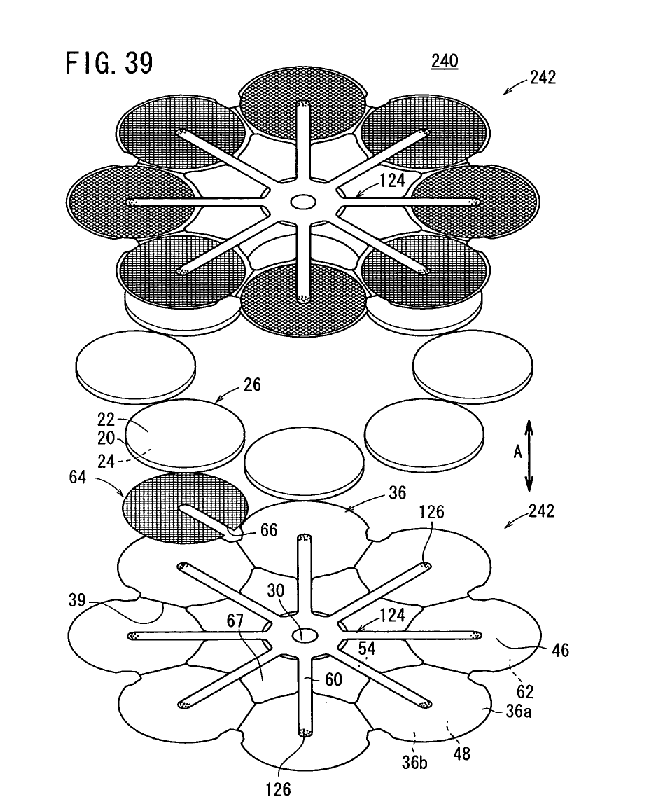

FIG. 39 is an exploded perspective view showing a fuel cell 240 according to a twelfth embodiment of the present invention.

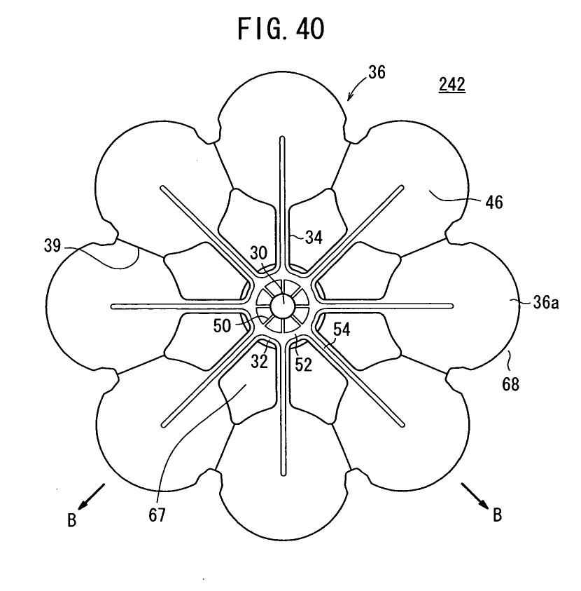

In the fuel cell 240, a channel member 124 is fixed to a surface of a separator 242 facing the anodes 24. As shown in FIG. 40, slits 50, a recess 52, and a fuel gas supply channel 54 are formed on the surface of the separator 242 facing the anodes 24 by, e.g., etching. An elastic channel member such as an electrically conductive mesh member 64 is provided on the surface 36a of each of the circular disks 36.

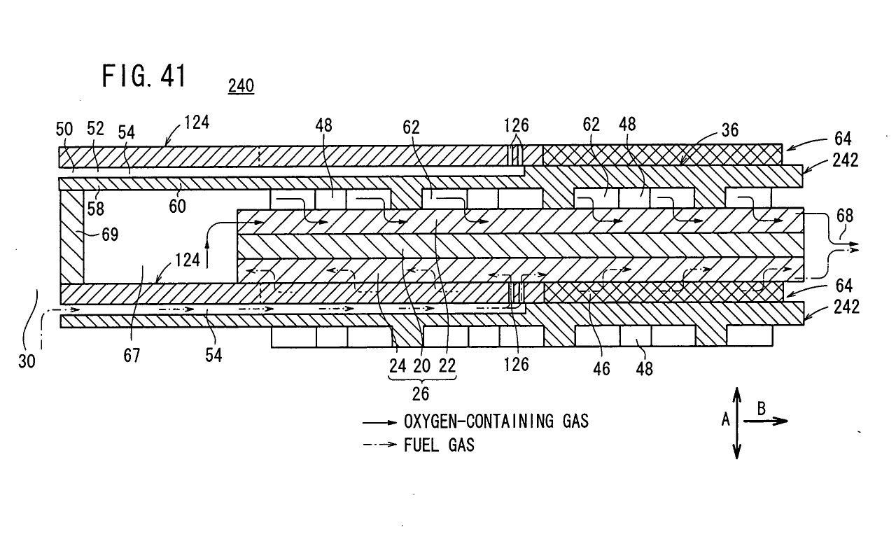

As shown in FIG. 41, in the twelfth embodiment, the fuel gas supplied to the fuel gas supply passage 30 flows along the fuel gas supply channel 54 formed between the separator 242 and the channel member 124. Then, the fuel gas is supplied to the anode 24 through the mesh member 64, from a plurality of fuel gas inlets 126 formed at the front end in each of the second bridges 60 of the channel member 124.

The air from the oxygen-containing gas supply unit 67 flows along the oxygen-containing gas channel 62 formed between the cathode 22 and each circular disk 36 in the direction indicated by the arrow B, and is supplied to the cathode 22.

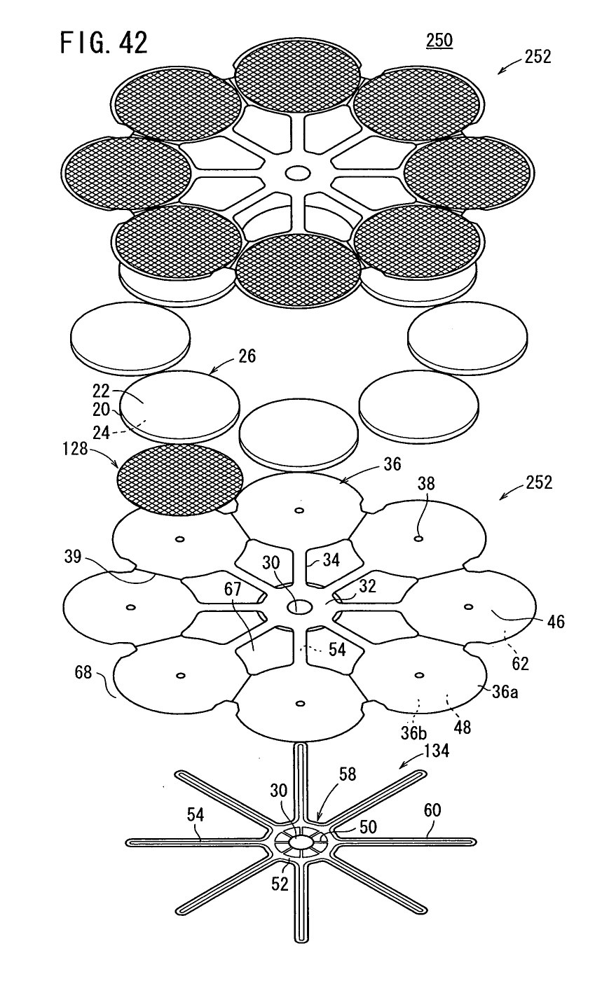

FIG. 42 is an exploded perspective view showing a fuel cell 250 according to a thirteenth embodiment of the present invention.

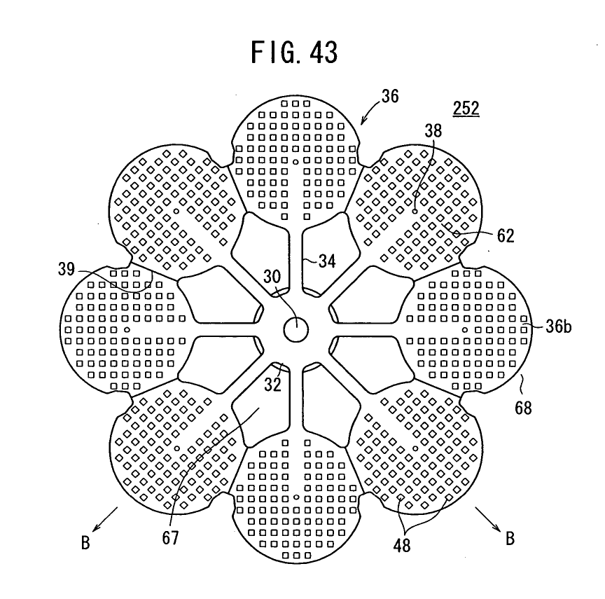

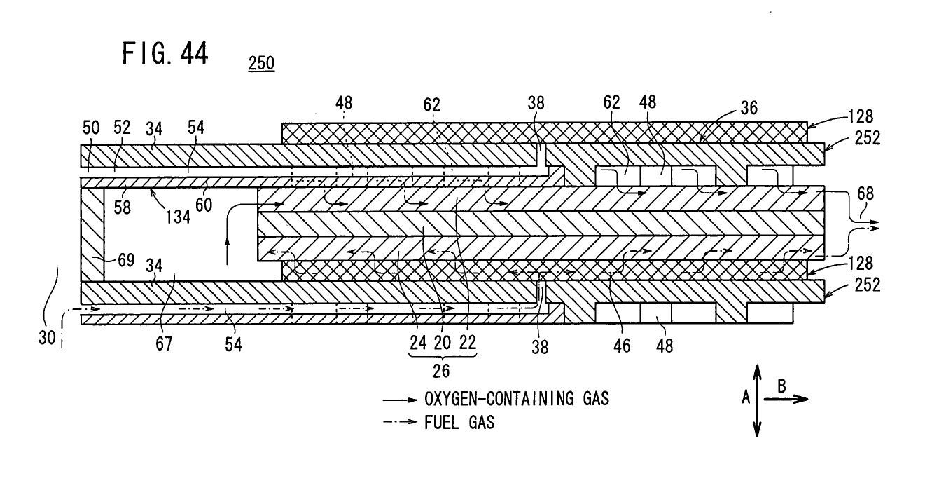

In the fuel cell 250, a channel member 134 is fixed to a surface of a separator 252 facing the cathodes 22. As shown in FIG. 43, a plurality of protrusions 48 are formed on the surface 36b of the separator 252 by, e.g., etching. The channel member 134 is fixed to the separator 132 from the first small diameter end portion 32, covering the first bridge 34 and the fuel gas inlet 38 of the circular disk 36 (see FIG. 44). The mesh member 128 is provided on the surface 36a of the separator 252.

In the thirteenth embodiment, as shown in FIG. 44, the fuel gas, the oxygen-containing gas, and the exhaust gas flow in substantially the same manner as in the case of the eleventh embodiment.

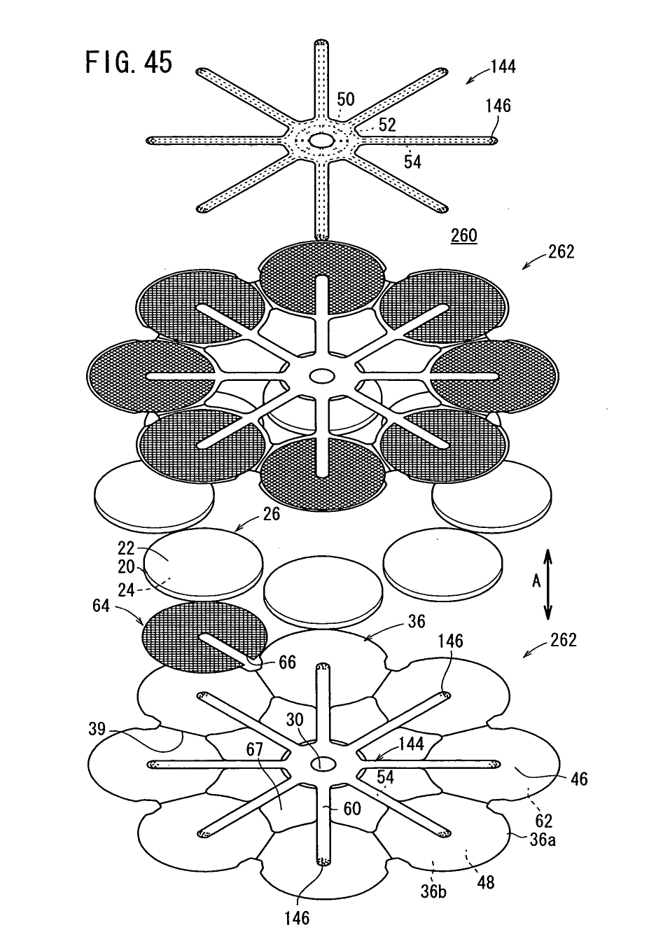

FIG. 45 is an exploded perspective view showing a fuel cell 260 according to a fourteenth embodiment of the present invention.

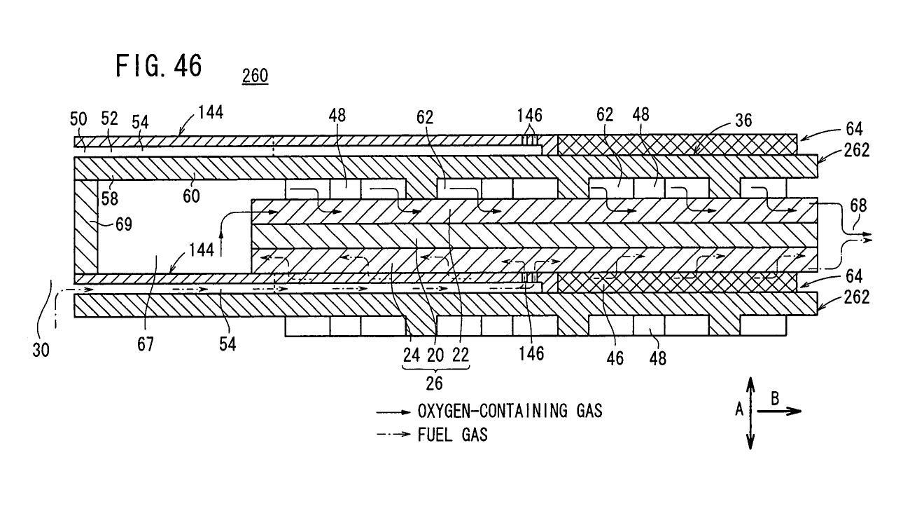

In the fuel cell 260, a channel member 144 is fixed to a surface of a separator 262 facing the anodes 24. In the fourteenth embodiment, as shown in FIG. 46, the fuel gas, the oxygen-containing gas, and the exhaust gas flow in substantially the same manner as in the case of the twelfth embodiment.

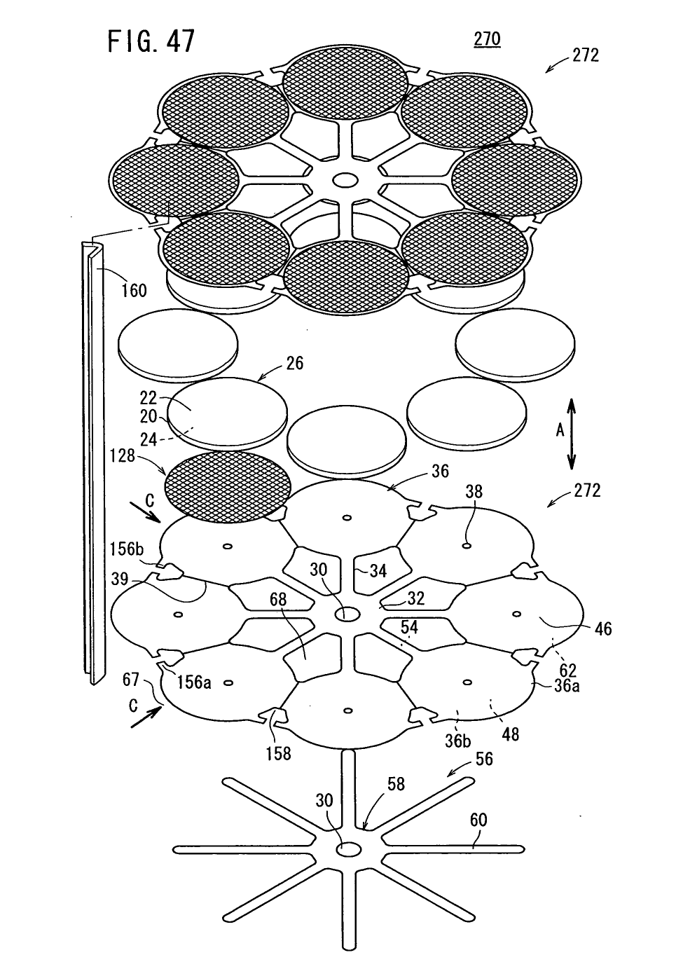

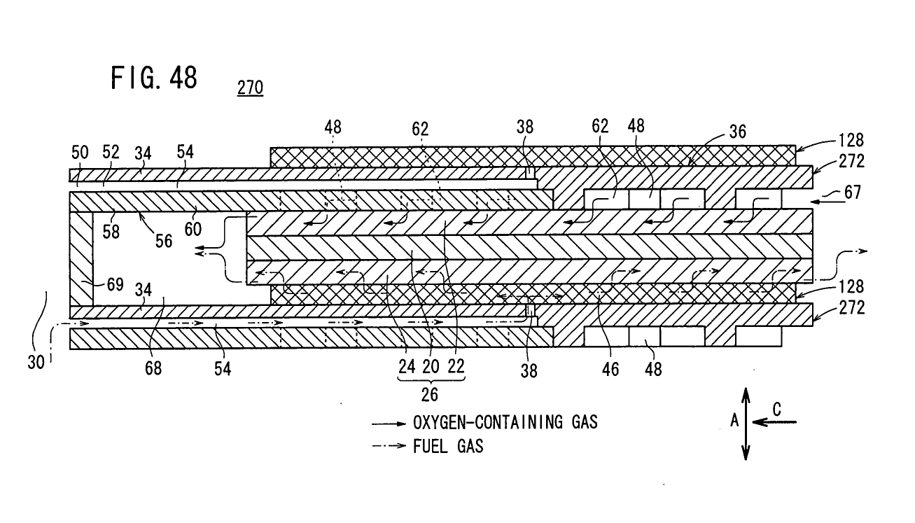

FIG. 47 is an exploded perspective view showing a fuel cell 270 according to a fifteenth embodiment of the present invention. In the fuel cell 270, a mesh member 128 is provided on a surface 36a of each of the circular disks 36 of a separator. A channel member 56 is fixed to a surface 36b of the circular disks 36. In the fifteenth embodiment, the oxygen-containing gas, the fuel gas, and the exhaust gas flow as shown in FIG. 48.

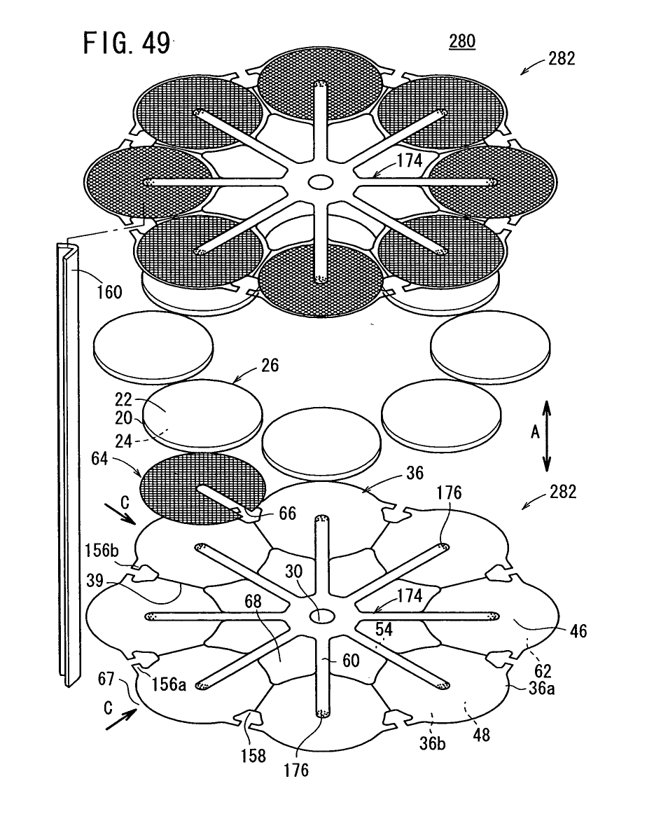

FIG. 49 is an exploded perspective view showing a fuel cell 280 according to a sixteenth embodiment of the present invention.

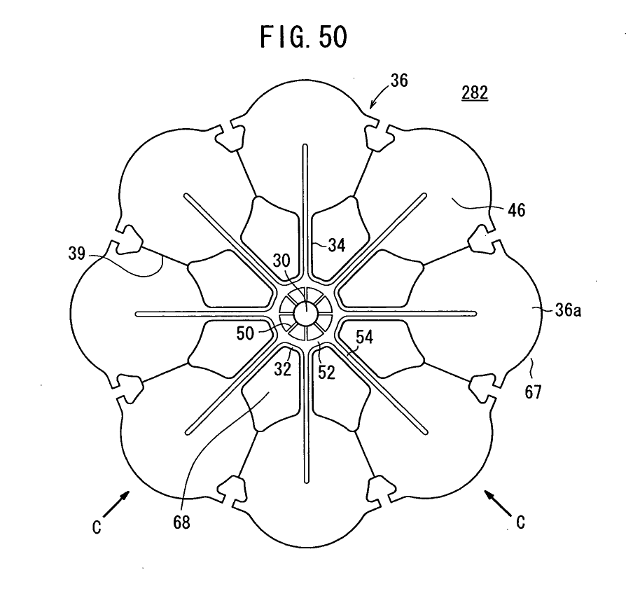

In the fuel cell 280, a channel member 174 is fixed to a surface 36a of a separator 282 facing the anodes 24. As shown in FIG. 50, slits 50, a recess 52, and a fuel gas supply channel 54 are formed on the surface 36a of the separator 282 by, e.g., etching. The slits 50, the recess 52, and the fuel gas supply channel 54 are connected to the fuel gas supply passage 30. Further, mesh members 64 are provided on the surface 36a of the separator 282.

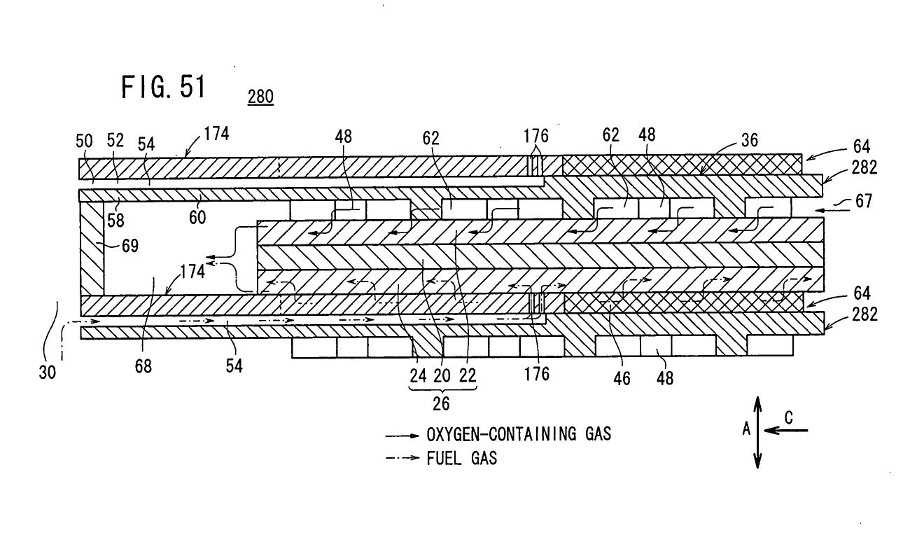

In the sixteenth embodiment, the oxygen-containing gas, the fuel gas, and the exhaust gas flow as shown in FIG. 51.

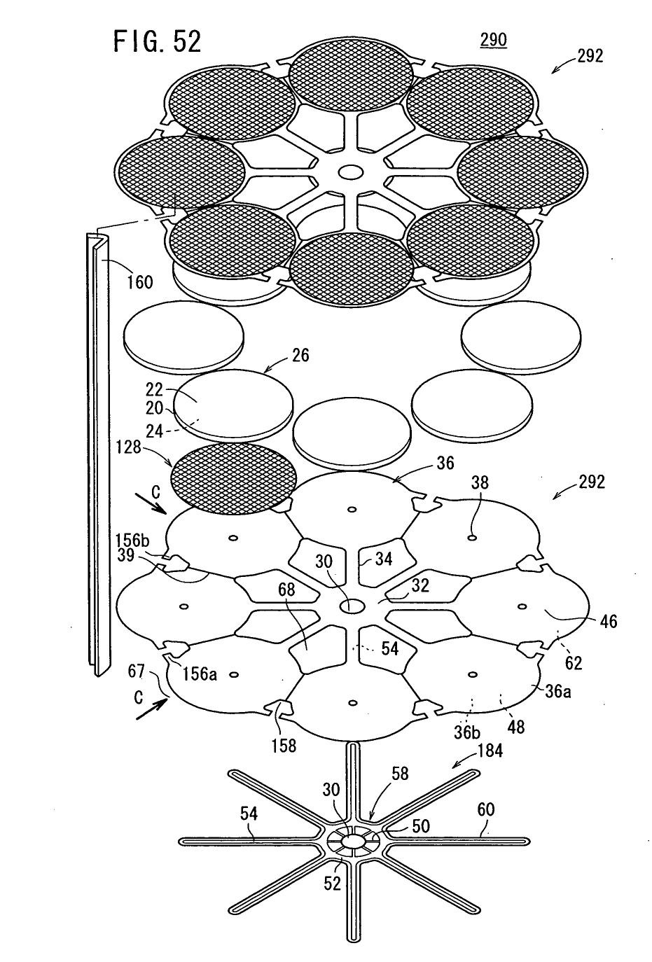

FIG. 52 is an exploded perspective view showing a fuel cell 290 according to a seventeenth embodiment of the present invention.

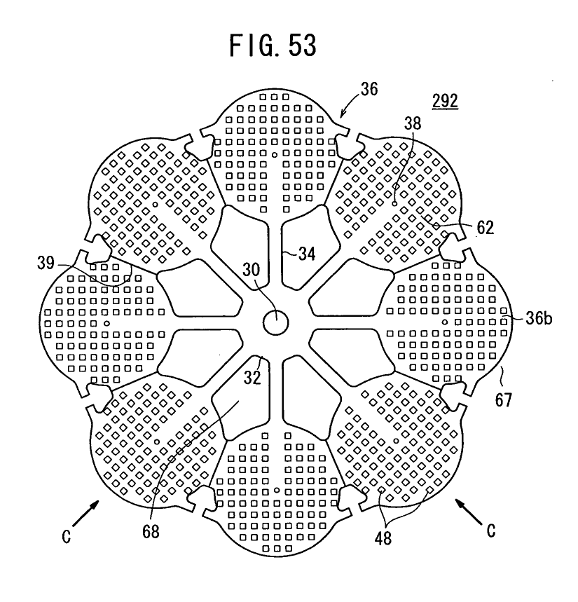

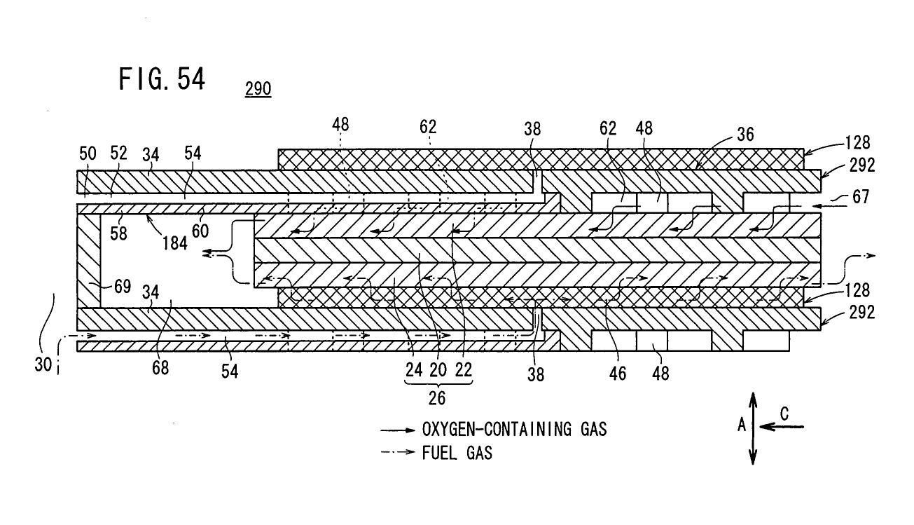

In the fuel cell 290, a channel member 184 is fixed to a surface 36b of a separator 292 facing the cathodes 22, and slits 50, a recess 52, and a fuel gas supply channel 54 are formed on the channel member 184 by, e.g., etching. As shown in FIG. 53, a plurality of protrusions 48 are formed on the surface 36b of the separator 292. In the seventeenth embodiment, the oxygen-containing gas, the fuel gas, and the exhaust gas flow as shown in FIG. 54.

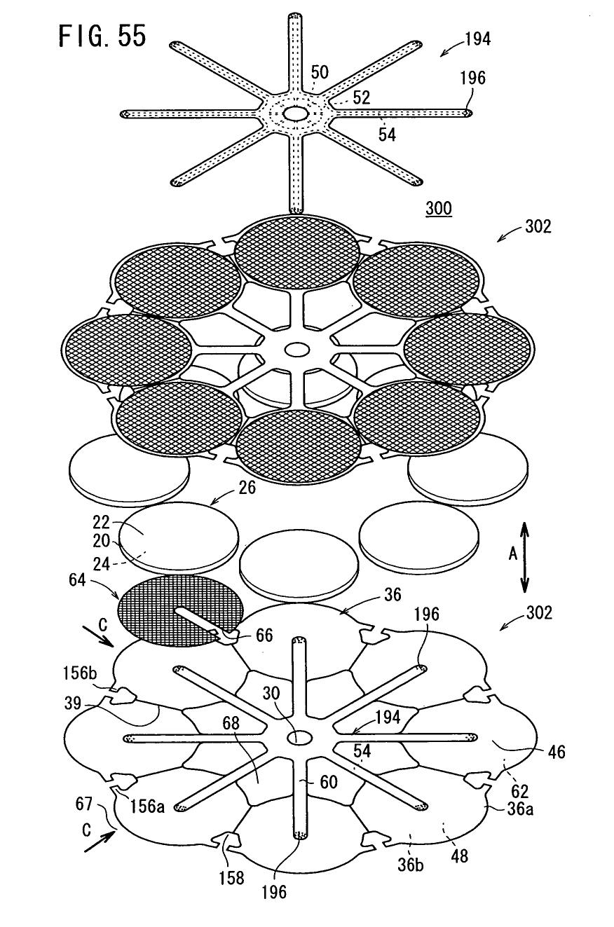

FIG. 55 is an exploded perspective view showing a fuel cell 300 according to an eighteenth embodiment of the present invention.

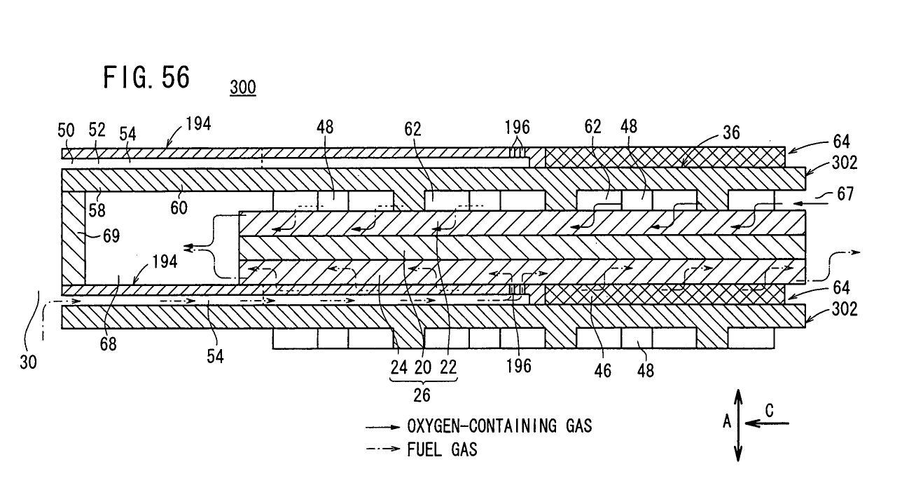

In the fuel cell 300, a channel member 194 is fixed to a surface of a separator 302 facing the anodes 24, and a mesh member 64 is provided on the surface 36a of the separator 302. In the eighteenth embodiment, the oxygen-containing gas, the fuel gas, and the exhaust gas flow as shown in FIG. 56.

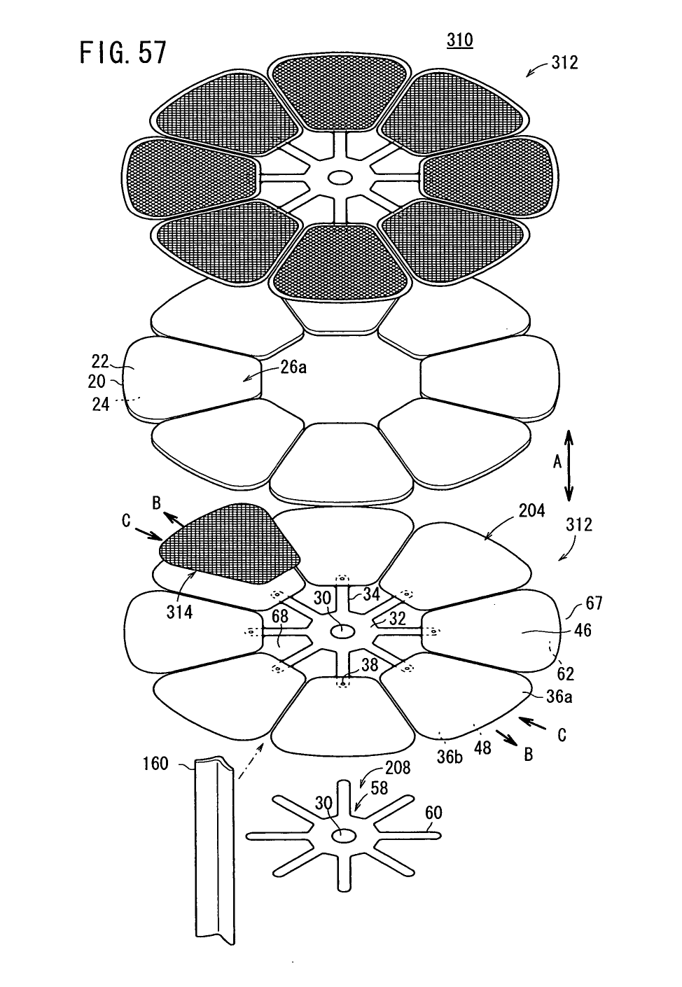

FIG. 57 is an exploded perspective view showing a fuel cell 310 according to a nineteenth embodiment of the present invention.

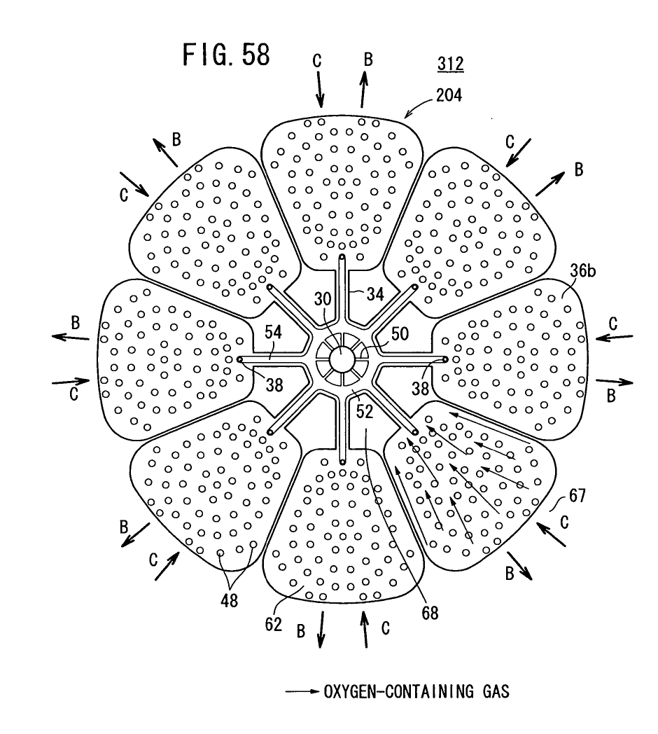

As shown in FIG. 58, in the fuel cell 310, slits 50, a recess 52, and a fuel gas supply channel 54 are formed on a surface 36b of a separator 312 by, e.g., etching. The fuel gas supply channel 54 is connected to fuel gas inlets 38 formed at the inner edge portions of the trapezoidal sections 204. A plurality of protrusions 48 are formed on the surface 36b of each of the trapezoidal sections 204 by, e.g., etching. A channel member 208 is fixed to the separator 312 to cover the slits 50, the recess 52, the fuel gas supply channel 54, and the fuel gas inlets 38. The channel member 208 has a flat shape.

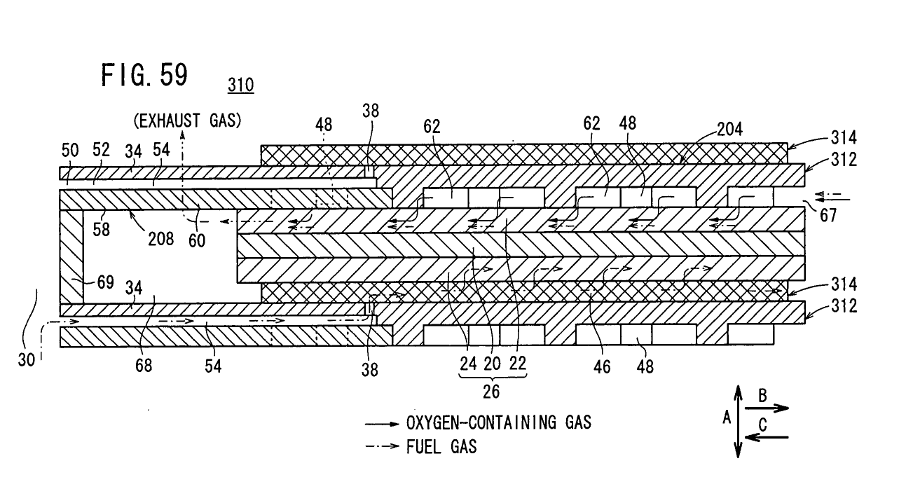

As shown in FIG. 57, a deformable elastic channel member such as an electrically conductive mesh member 314 is provided on a surface 36a of each of the trapezoidal sections 204. The mesh member 314 has a substantially trapezoidal shape, and the size of the mesh member 314 is larger than the area of protrusions 48 formed on the surface 36b of the trapezoidal section 204. In the nineteenth embodiment, the oxygen-containing gas, the fuel gas, and the exhaust gas flow as shown in FIG. 59.

The nineteenth embodiment substantially adopts the structure of the fifteenth embodiment. However, the present invention is not limited in this respect. The technical features of the nineteenth embodiment may be based on the structures of the sixteenth to eighteenth embodiments, or the structures of the eleventh to fourteenth embodiments in which the oxygen-containing gas flows from the inside to the outside of the separators.

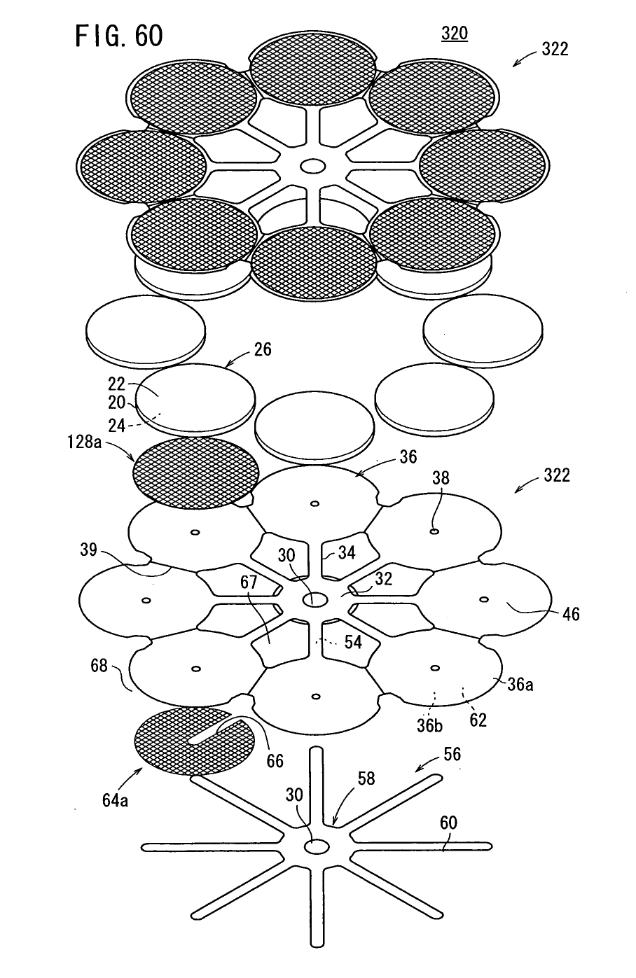

FIG. 60 is an exploded perspective view showing a fuel cell 320 according to a twentieth embodiment of the present invention. In a separator 322 of the fuel cell 320, each of the circular disks 36 has a substantially planar surface 36a which contacts the anode 24. A deformable first elastic channel member such as an electrically conductive first mesh member 128a is provided on the surface 36a of the circular disk 36. The first mesh member 128a forms a fuel gas channel 46 for supplying the fuel gas along an electrode surface of the anode 24. The first mesh member 128a tightly contacts the anode 24. For example, the first mesh member 128a is made of wire rod material of stainless steel (SUS material), and has a substantially circular disk shape. The thickness of the first mesh member 128a is determined such that the first mesh member 128a is deformed elastically desirably when a load in the stacking direction indicated by the arrow A is applied to the first mesh member 128a.

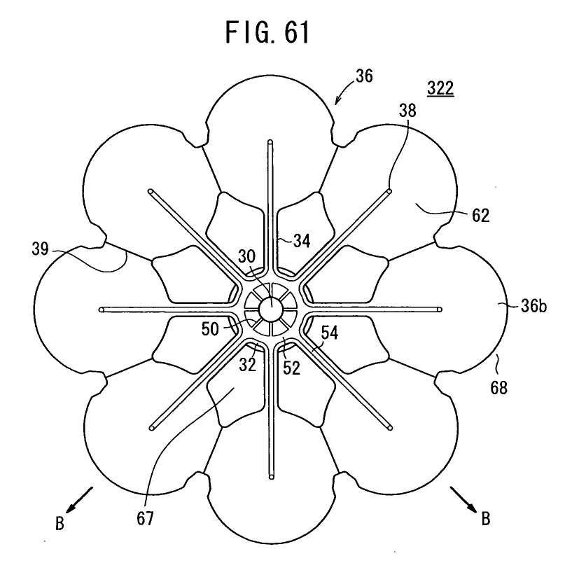

As shown in FIG. 61, each of the circular disks 36 has a substantially planar surface 36b which contacts the cathode 22. A deformable second elastic channel member such as an electrically conductive second mesh member 64a is provided on the surface 36b of the circular disk 36. The second mesh member 64a forms an oxygen-containing gas channel 62 for supplying the oxygen-containing gas along an electrode surface of the cathode 22 (see FIG. 60).

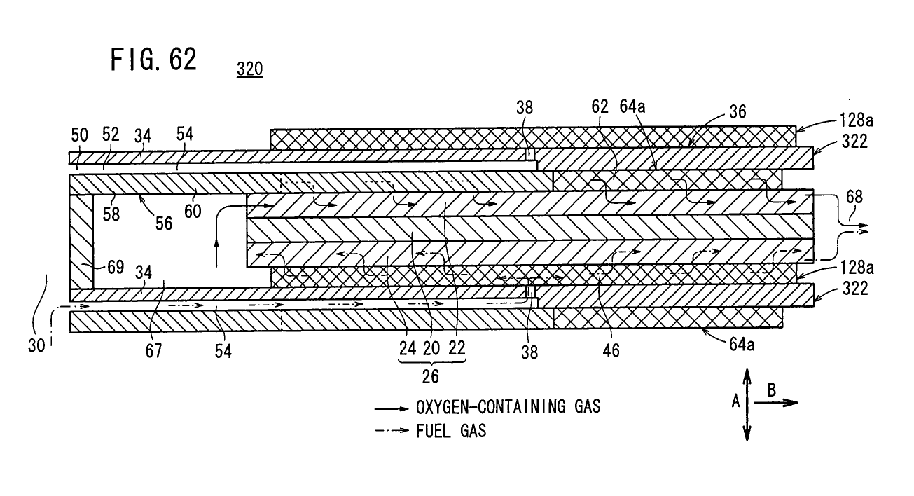

As shown in FIG. 62, the area where the second mesh member 64a is provided, i.e., the power generation area of the cathode 22 is smaller than the area where the first mesh member 128a is provided, i.e., the power generation area of the anode 24. The oxygen-containing gas channel 62 formed in the second mesh member 64a is connected to the oxygen-containing gas supply unit 67. The oxygen-containing gas is supplied in the direction indicated by the arrow B through the space between the inner circumferential edge of the electrolyte electrode assembly 26 and the inner circumferential edge of the circular disk 36.

As shown in FIG. 62, in the twentieth embodiment, the anode 24 of the electrolyte electrode assembly 26 contacts the first mesh member 128a, and the cathode 22 of the electrolyte electrode assembly 26 contacts the second mesh member 64a. In this state, the load in the stacking direction indicated by the arrow A is applied to the components of the fuel cell 320. Since the first and second mesh members 128a, 64a are deformable, the first mesh member 128a tightly contacts the anode 24, and the second mesh member 64a tightly contacts the cathode 22.

In the structure, the dimensional errors or distortions that occur at the time of production in the electrolyte electrode assembly 26 or the separator 322 can suitably be absorbed by elastic deformation of the first and second mesh members 128a, 64a. Thus, in the twentieth embodiment, damage at the time of stacking the components of the fuel cell 320 is prevented. Since the first and second mesh members 128a, 64a contact the anode 24 and the cathode 22 at many points, improvement in the performance of collecting electricity from the fuel cell 320 is achieved. Therefore, the fuel cells 320 can be stacked together with a small load.

Even in the case of using the electrolyte electrode assembly 26 (so called electrolyte supported cell type MEA) having the structure in which the cathode 22 and the anode 24 are thin in comparison with the electrolyte 20, the stress applied to the anode 24 by the mesh member 128a is relaxed suitably, and reduction in the damage is achieved advantageously. Further, even in the case of using the electrolyte electrode assembly 26 (so called anode supported cell type MEA) with small membrane strength, having the thin electrolyte 20 and the thin cathode 22, the stress applied to the electrolyte 20 and the cathode 22 by the second mesh member 64 is relaxed suitably, and reduction in the damage of the cathode 22 is achieved advantageously.

The fuel gas is diffused smoothly inside the first mesh member 128a, and the oxygen-containing gas is diffused smoothly inside the second mesh member 64a. Thus, the fuel gas and the oxygen-containing gas are distributed uniformly to the anode 24 and the cathode 22, respectively, and the stable and suitable power generation can be performed advantageously.

Further, no protrusions or recesses need to be formed on the surfaces 36a, 36b facing the anode 24 and the cathode 22 for forming gas channels or current collectors. Thus, the shape of the separator 322 is simplified significantly, and the separator 322 can be produced at low cost economically.

Further, the area where the second mesh member 64a is provided is smaller than the area where the first mesh member 128a is provided (see FIG. 62). Therefore, even if the exhaust gas flows around to the anode 24 from the outside of the electrolyte electrode assembly 26, the power generation area is not present in the outer circumferential edge of the cathode 22 opposite to the outer circumferential edge of the anode 24.

Thus, fuel consumption by the circulation current does not increase significantly, and a large electromotive force can be collected easily. Accordingly, the performance of collecting electricity is improved, and the fuel utilization ratio is achieved advantageously. Further, the present invention can be carried out simply by using the first and second mesh members 128a, 64a as the first and second elastic channel members. Thus, the structure of the present invention is simplified economically.

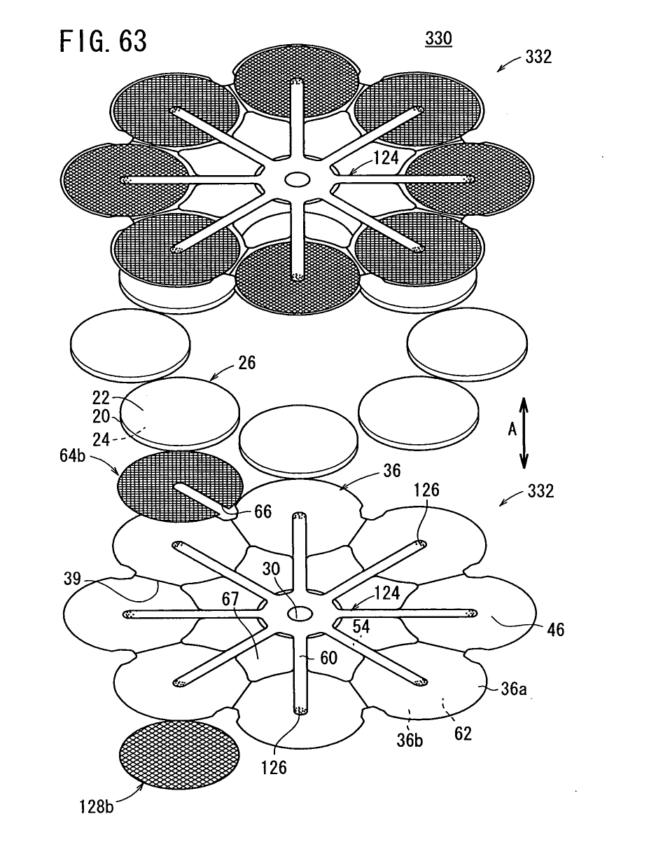

FIG. 63 is an exploded perspective view showing a fuel cell 330 according to a twenty-first embodiment of the present invention.

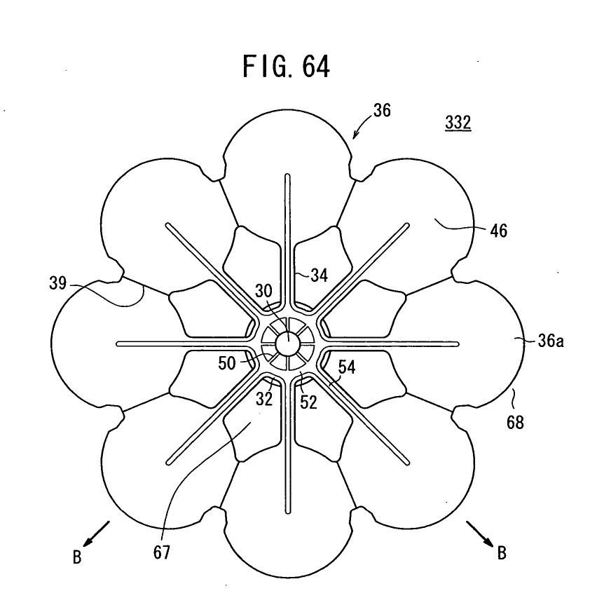

In the fuel cell 330, a channel member 124 is fixed to a surface of a separator 332 facing the anodes 24. As shown in FIG. 64, slits 50, a recess 52, and a fuel gas supply channel 54 are formed on the surface of the separator 332 facing the anodes 24 by, e.g., etching.

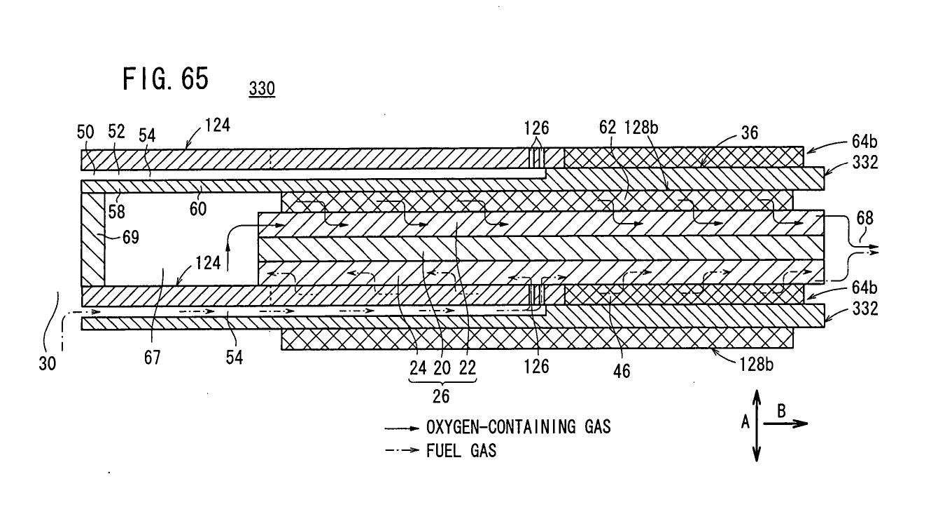

A first elastic channel member such as an electrically conductive first mesh member 64b is formed on a surface 36a of the circular disk 36, and a second elastic channel member such as an electrically conductive second mesh member 128b are formed on a surface 36b of the circular disk 36 (see FIGS. 63 and 65).

The first mesh member 64b has a cutout 66, and the second mesh member 128b has a substantially circular disk shape. The area where the second mesh member 128b is provided is smaller than the area where the first mesh member 64b is provided. No fuel gas inlets 38 are required for the circular disks 36.

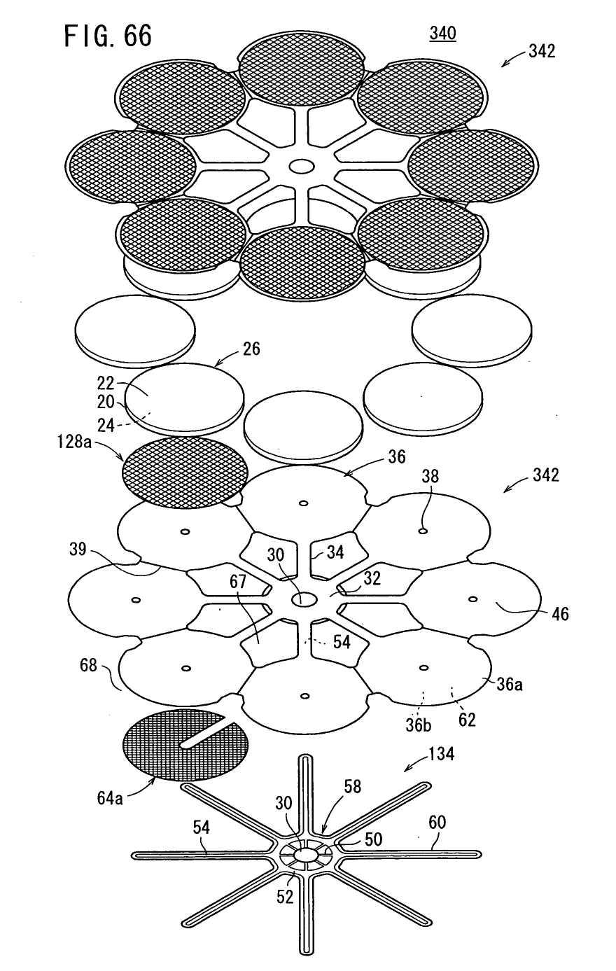

FIG. 66 is an exploded perspective view showing a fuel cell 340 according to a twenty-second embodiment of the present invention.

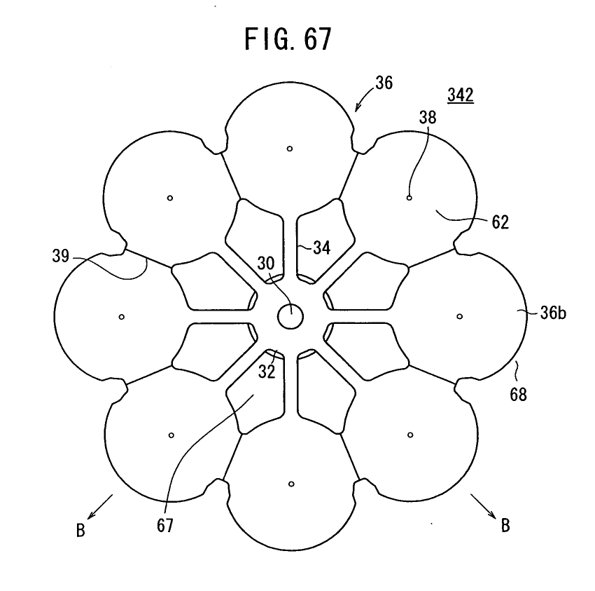

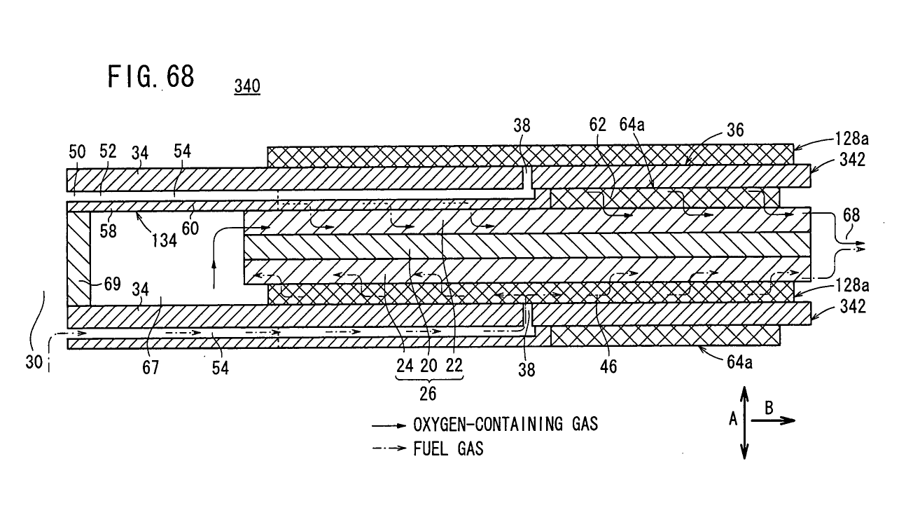

In the fuel cell 340, a channel member 134 is fixed to a surface of a separator 342 facing the cathodes 22. As shown in FIGS. 66 and 67, both surfaces of the separator 342 are substantially planar. The channel member 134 is fixed to a surface 36b of the separator 342 from the first small diameter end portion 32 to cover the first bridge 34 and the fuel gas inlet 38 of the circular disk 36 (see FIG. 68). In the twenty-second embodiment, as shown in FIG. 68, the fuel gas, the oxygen-containing gas, and the exhaust gas flow in substantially the same manner as in the case of the twentieth embodiment.

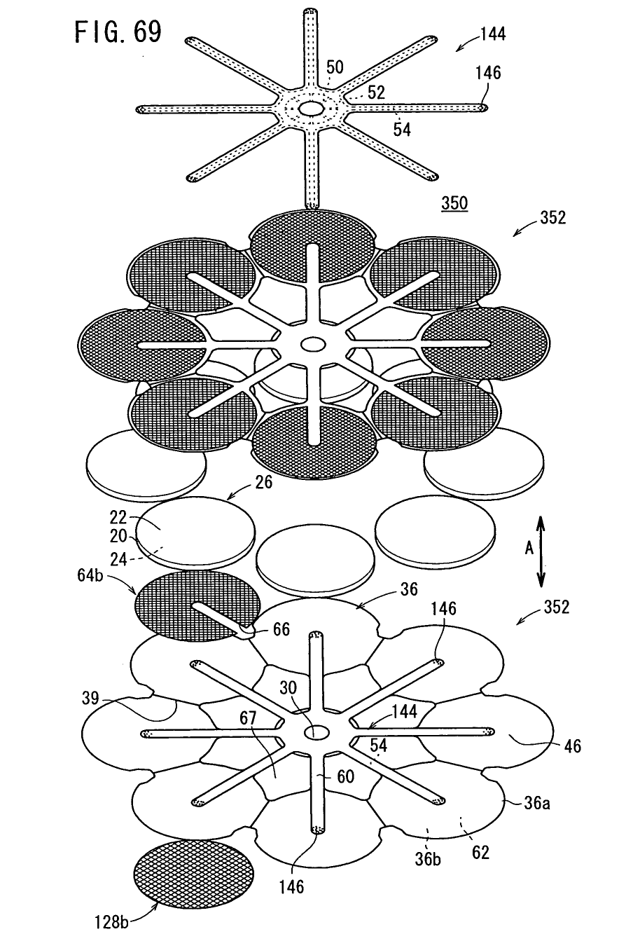

FIG. 69 is an exploded perspective view showing a fuel cell 350 according to a twenty-third embodiment of the present invention.

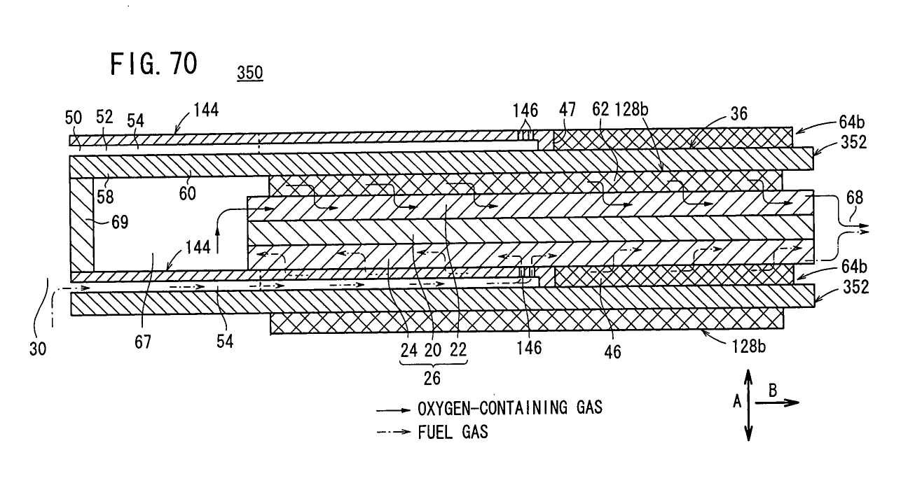

In the fuel cell 350, a channel member 144 is fixed to a surface of a separator 352 facing the anodes 24. In the twenty-third embodiment, as shown in FIG. 70, the fuel gas, the oxygen-containing gas, and the exhaust gas flow in substantially the same manner as in the case of the twenty-first embodiment.

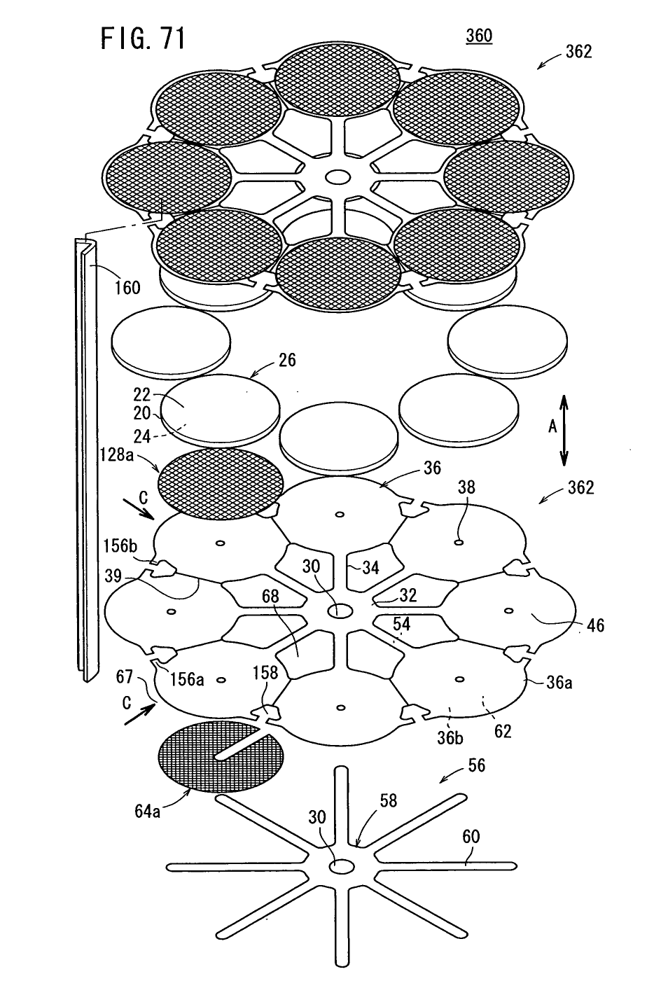

FIG. 71 is an exploded perspective view showing a fuel cell 360 according to a twenty-fourth embodiment of the present invention.

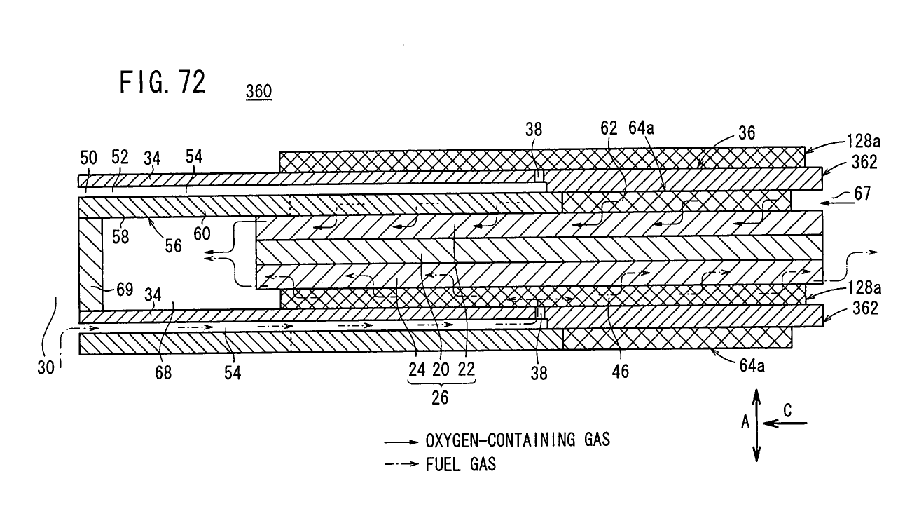

In the fuel cell 360, a channel member 56 is fixed to a surface 36b of each of the circular disks 36 of a separator 362, and a first mesh member 128a and a second mesh member 64a are formed on surfaces 36a, 36b of each of the circular disks 36. In the twenty-fourth embodiment, the oxygen-containing gas, the fuel gas, and the exhaust gas flow as shown in FIG. 72.

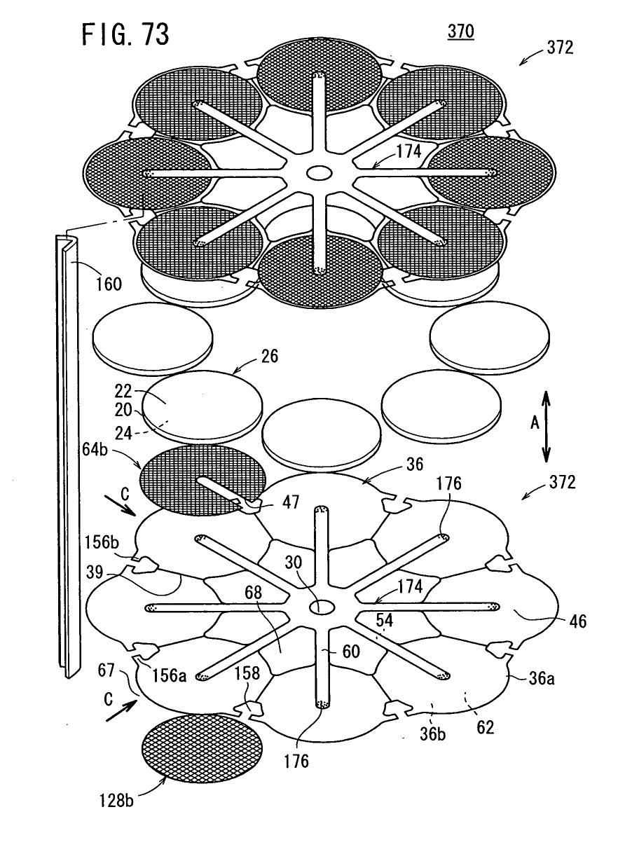

FIG. 73 is an exploded perspective view showing a fuel cell 370 according to a twenty-fifth embodiment of the present invention.

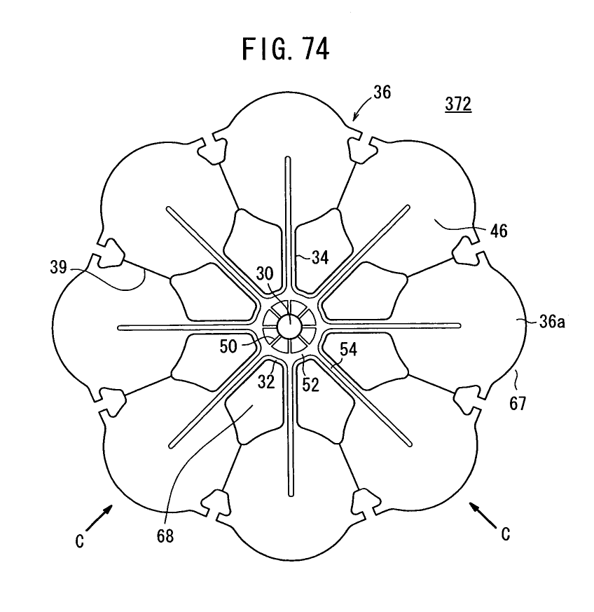

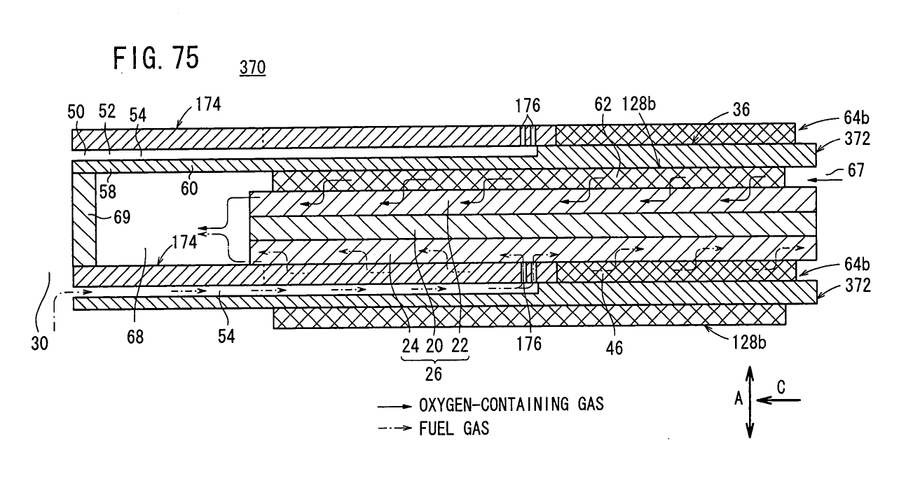

In the fuel cell 370, a channel member 174 is fixed to a surface of a separator 372 facing the anodes 24. As shown in FIG. 74, slits 50, a recess 52, and a fuel gas supply channel 54 are formed on the surface 36a of the separator 372 by, e.g., etching. The slits 50, the recess 52 and the fuel gas supply channel 54 are connected to the fuel gas supply passage 30. In the twenty-fifth embodiment, the oxygen-containing gas, the fuel gas, and the exhaust gas flow as shown in FIG. 75.

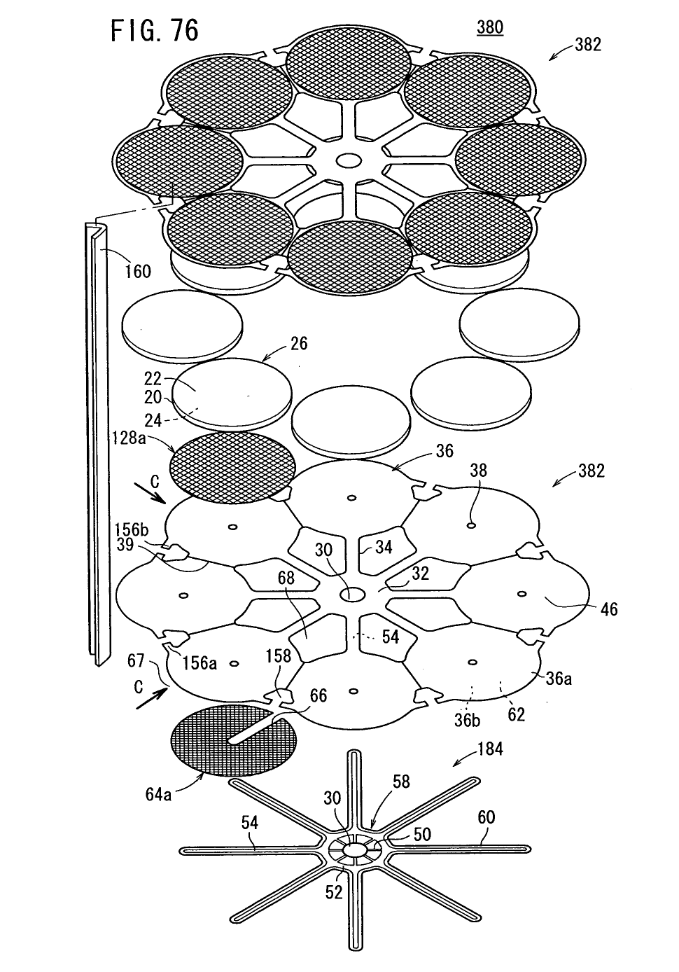

FIG. 76 is an exploded perspective view showing a fuel cell 380 according to a twenty-sixth embodiment of the present invention.

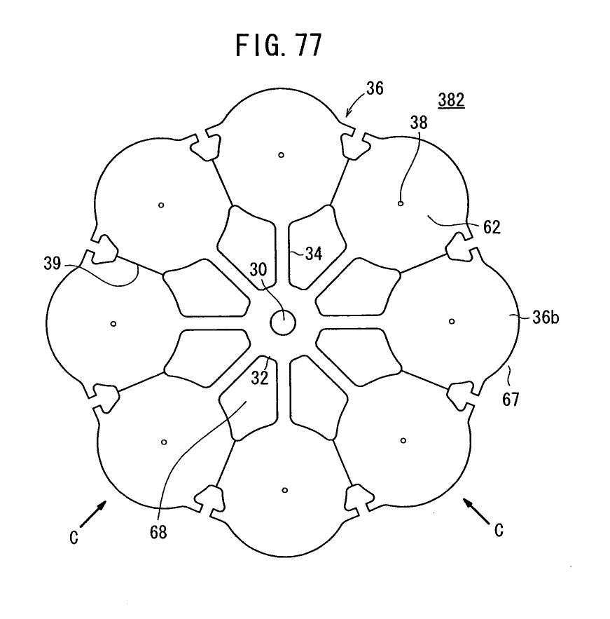

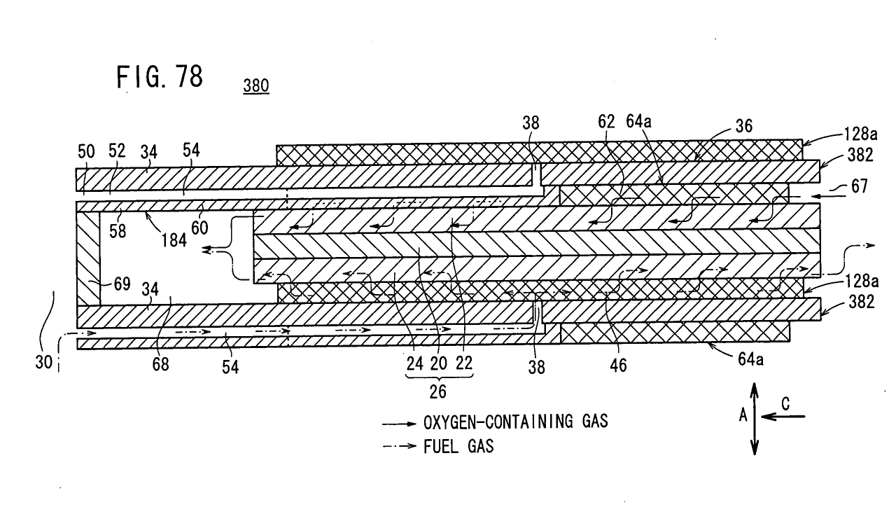

In the fuel cell 380, a channel member 184 is fixed to a surface of a separator 382 facing the cathodes 22, and slits 50, a recess 52, and a fuel gas supply channel 54 are formed in the channel member 184 by, e.g., etching. As shown in FIGS. 76 and 77, both surfaces of the separator 382 are planar. In the twenty-sixth embodiment, the oxygen-containing gas, the fuel gas, and the exhaust gas flow as shown in FIG. 78.

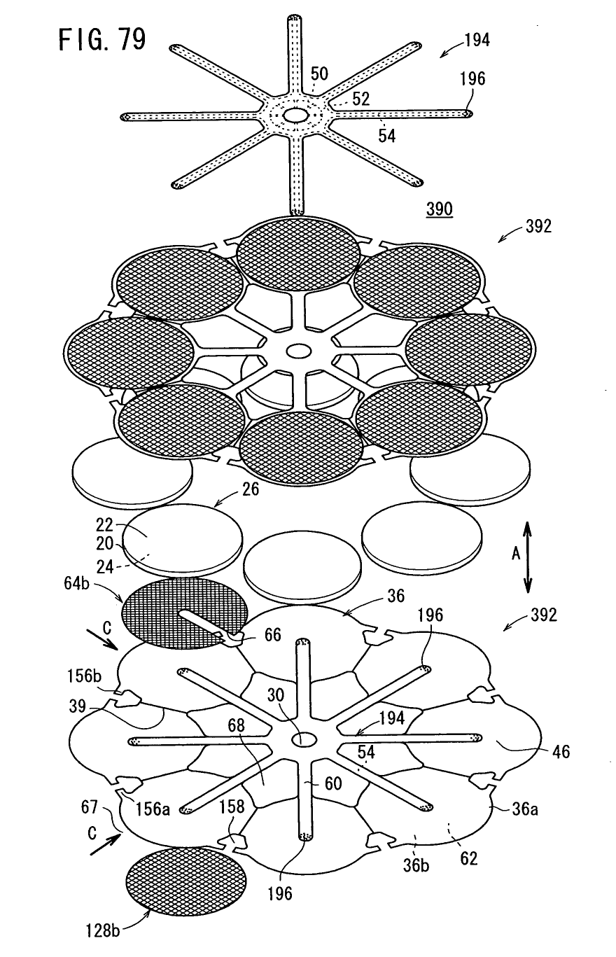

FIG. 79 is an exploded perspective view showing a fuel cell 390 according to a twenty-seventh embodiment of the present invention.

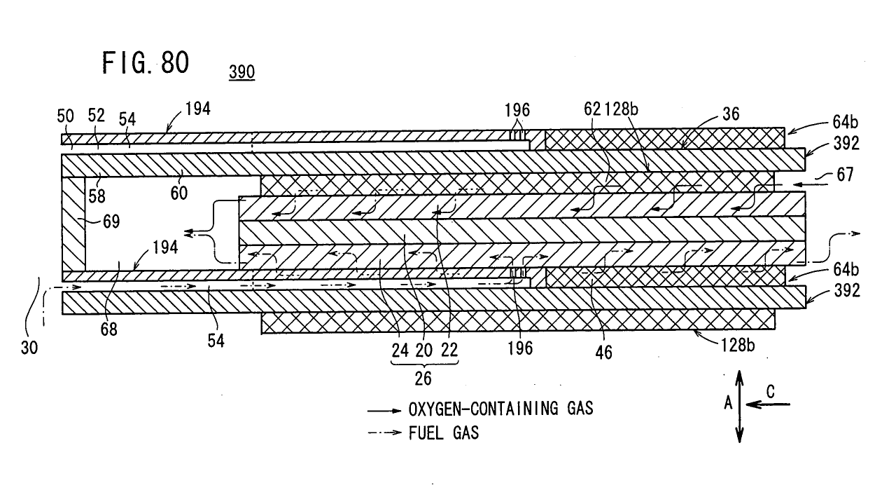

In the fuel cell 390, a channel member 194 is fixed to a surface of a separator 392 facing the anodes 24, and slits 50, a recess 52, and a fuel gas supply channel 54 are formed in the channel member 194 by, e.g., etching. In the twenty-seventh embodiment, the oxygen-containing gas, the fuel gas, and the exhaust gas flow as shown in FIG. 80.

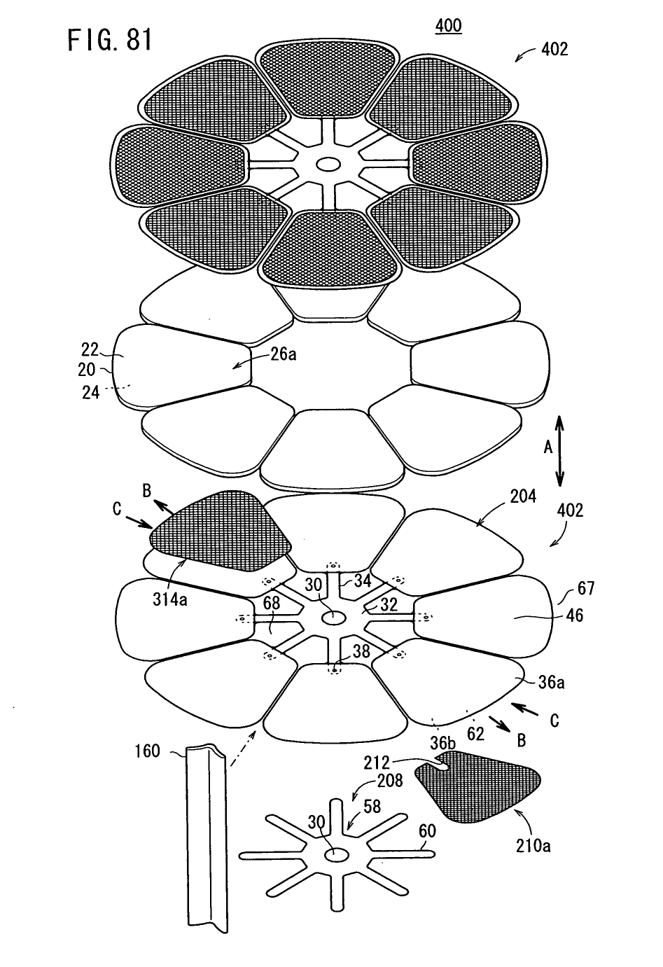

FIG. 81 is an exploded perspective view showing a fuel cell 400 according to a twenty-eighth embodiment of the present invention.

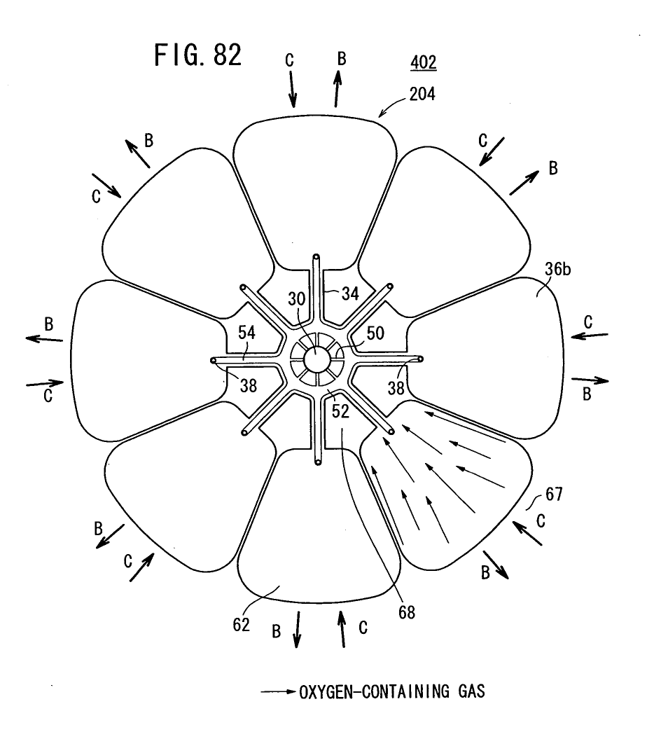

As shown in FIG. 82, in the fuel cell 400, slits 50, a recess 52, and a fuel gas supply channel 54 are formed on a surface 36b of a separator 402 by, e.g., etching. The fuel gas supply channel 54 is connected to fuel gas inlets 38 formed at the inner edge portions of the trapezoidal sections 204. A channel member 208 is fixed to the separator 402 to cover the slits 50, the recess 52, the fuel gas supply channel 54, and the fuel gas inlets 38. The channel member 208 has a flat shape.

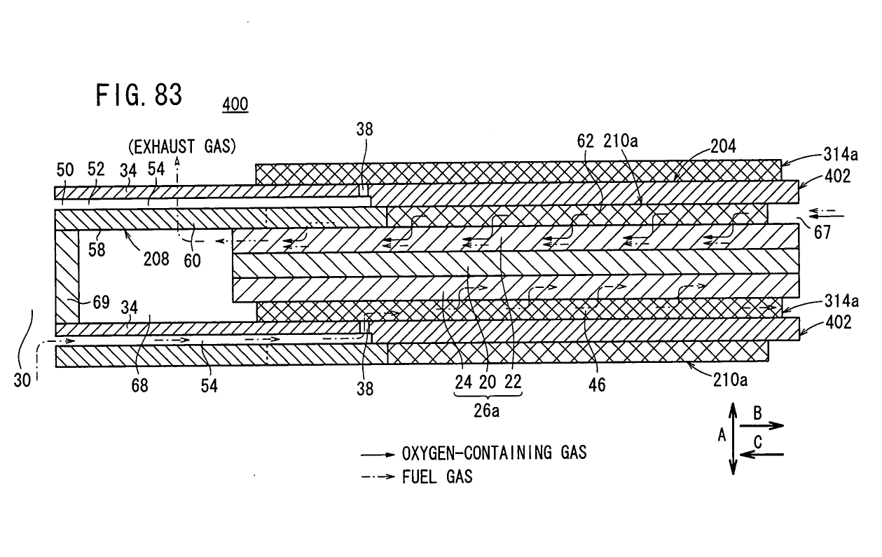

As shown in FIG. 81, a deformable first elastic member such as an electrically conductive first mesh member 314a is provided on a surface 36a of each of the trapezoidal sections 204. Further, a deformable second elastic channel member such as an electrically conductive second mesh member 210a is formed on a surface 36b of each of the trapezoidal sections 204. Each of the first and second mesh members 314a, 210a has a substantially trapezoidal shape. The area where the second mesh member 210a is provided is smaller than the area where the first mesh member 314a is provided. In the twenty-eighth embodiment, the oxygen-containing gas, the fuel gas, and the exhaust gas flow as shown in FIG. 83.

The twenty-eighth embodiment substantially adopts the structure of the twenty-fourth embodiment. However, the present invention is not limited in this respect. The technical features of the twenty-eighth embodiment may be based on the structures of the twenty-fifth to twenty-seventh embodiments, or the structures of the twentieth to twenty-third embodiments in which the oxygen-containing gas flows from the inside to the outside of the separators.

While the invention has been particularly shown and described with reference to preferred embodiments, it will be understood that variations and modifications can be effected thereto by those skilled in the art without departing from the spirit and scope of the invention as defined by the appended claims.

What is claimed is:

1. A fuel cell including an electrolyte electrode assembly and a pair of separators sandwiching said electrolyte electrode assembly, said electrolyte electrode assembly including an anode, a cathode, and an electrolyte interposed between said anode and said cathode, said separators each comprising a single plate, said fuel cell comprising:
protrusions provided on one surface of said separator to form a fuel gas channel for supplying a fuel gas along an electrode surface of said anode;
a deformable elastic channel member provided on the other surface of said separator to form an oxygen-containing gas channel for supplying an oxygen-containing gas along an electrode surface of said cathode, said deformable elastic channel member tightly contacting said cathode; and
a channel member provided on the one surface or the other surface of said separator to form a fuel gas supply channel connected to a fuel gas supply unit and a fuel gas inlet for supplying a fuel gas to said fuel gas channel.

2. A fuel cell according to claim 1, further comprising an exhaust gas channel for discharging the fuel gas and the oxygen-containing gas consumed in the reaction in said electrolyte electrode assembly as an exhaust gas in a stacking direction of said electrolyte electrode assembly and said separators, wherein
said fuel gas supply unit for supplying the fuel gas before consumption in the stacking direction is provided hermetically inside said exhaust gas channel; and
said fuel gas supply channel connects said fuel gas channel and said fuel gas supply unit, and is provided along the separator surface to intersect said exhaust gas channel extending in the stacking direction.

3. A fuel cell according to claim 2, wherein said exhaust gas channel is provided at the central regions of said separators.

4. A fuel cell according to claim 2, wherein said fuel gas supply unit is provided hermetically at the central region of said exhaust gas channel.

5. A fuel cell according to claim 1, further comprising an oxygen-containing gas supply unit for supplying the oxygen-containing gas before consumption from the outer circumference of said electrolyte electrode assembly to said oxygen-containing gas supply channel.

6. A fuel cell according to claim 1, further comprising an exhaust gas channel for discharging the fuel gas and the oxygen-containing gas consumed in the reaction in said electrolyte electrode assembly as an exhaust gas in a stacking direction of said electrolyte electrode assembly and said separators; and
an oxygen-containing gas supply unit for allowing the oxygen-containing gas before consumption to flow in the stacking direction to supply the oxygen-containing gas to said oxygen-containing gas channel, wherein
said fuel gas supply unit for supplying the fuel gas before consumption in the stacking direction is provided hermetically inside said oxygen-containing gas supply unit; and
said fuel gas supply channel connects said fuel gas channel and said fuel gas supply unit, and is provided along the separator surface to intersect said oxygen-containing gas supply unit extending in the stacking direction.

7. A fuel cell according to claim 6, wherein said exhaust gas channel is provided around said separators.

8. A fuel cell according to claim 6, wherein said fuel gas supply unit is provided hermetically at the central regions of said separators.

9. A fuel cell according to claim 6, wherein said fuel gas inlet is provided at the center of said electrolyte electrode assembly or at an upstream position deviated from the center of said electrolyte electrode assembly in a flow direction of the oxygen-containing gas.

10. A fuel cell according to claim 6, wherein said electrolyte electrode assembly comprises a plurality of electrolyte electrode assemblies, said fuel cell further comprising an oxygen-containing gas supply unit for supplying the oxygen-containing gas before consumption to said oxygen-containing gas supply channel from the inner circumference of said electrolyte electrode assemblies arranged along a virtual circle.

11. A fuel cell according to claim 1, wherein an area where said elastic channel member is provided is smaller than a power generation area of said anode.

12. A fuel cell according to claim 1, wherein said elastic channel member is an electrically conductive metal mesh member.

13. A fuel cell according to claim 1, wherein said protrusions are solid portions formed on one surface of said separator by etching.

14. A fuel cell according to claim 1, wherein said electrolyte electrode assembly comprises a plurality of electrolyte electrode assemblies arranged along a virtual circle concentric with the center of said separators.

15. A fuel cell according to claim 1, wherein the surface area of said cathode is smaller than the surface area of said anode.

16. A fuel cell according to claim 15, wherein the outer diameter of said elastic channel member and the outer diameter of said cathode are determined to correspond to the outer diameter of said anode excluding an outer circumferential edge of said anode exposed to the oxygen-containing gas in an exhaust gas which flows around to said anode from the outside of said cathode.

17. A fuel cell according to claim 16, wherein the outer diameter of said elastic channel member is not less than the outer diameter of said cathode.

18. A fuel cell including an electrolyte electrode assembly and a pair of separators sandwiching said electrolyte electrode assembly, said electrolyte electrode assembly including an anode, a cathode, and an electrolyte interposed between said anode and said cathode, said separators each comprising a single plate, said fuel cell comprising:
protrusions provided on one surface of said separator to form an oxygen-containing gas channel for supplying an oxygen-containing gas along an electrode surface of said cathode;
a deformable elastic channel member provided on the other surface of said separator to form a fuel gas channel for supplying a fuel gas along an electrode surface of said anode, said deformable elastic channel member tightly contacting said anode; and
a channel member provided on the one surface or the other surface of said separator to form a fuel gas supply channel connected to a fuel gas supply unit and a fuel gas inlet for supplying a fuel gas to said fuel gas channel.

19. A fuel cell according to claim 18, further comprising an exhaust gas channel for discharging the fuel gas and the oxygen-containing gas consumed in the reaction in said electrolyte electrode assembly as an exhaust gas in a stacking direction of said electrolyte electrode assembly and said separators, wherein
said fuel gas supply unit for supplying the fuel gas before consumption in the stacking direction is provided hermetically inside said exhaust gas channel; and
said fuel gas supply channel connects said fuel gas channel and said fuel gas supply unit, and is provided along the separator surface to intersect said exhaust gas channel extending in the stacking direction.

20. A fuel cell according to claim 19, wherein said exhaust gas channel is provided at the central regions of said separators.

21. A fuel cell according to claim 19, wherein said fuel gas supply unit is provided hermetically at the central region of said exhaust gas channel.

22. A fuel cell according to claim 18, further comprising an oxygen-containing gas supply unit for supplying the oxygen-containing gas before consumption from the outer circumference of said electrolyte electrode assembly to said oxygen-containing gas supply channel.

23. A fuel cell according to claim 18, further comprising an exhaust gas channel for discharging the fuel gas and the oxygen-containing gas consumed in the reaction in said electrolyte electrode assembly as an exhaust gas in a stacking direction of said electrolyte electrode assembly and said separators; and
an oxygen-containing gas supply unit for allowing the oxygen-containing gas before consumption to flow in the stacking direction to supply the oxygen-containing gas to said oxygen-containing gas channel, wherein
said fuel gas supply unit for supplying the fuel gas before consumption in the stacking direction is provided hermetically inside said oxygen-containing gas supply unit; and
said fuel gas supply channel connects said fuel gas channel and said fuel gas supply unit, and is provided along the separator surface to intersect said oxygen-containing gas supply unit extending in the stacking direction.

24. A fuel cell according to claim 23, wherein said exhaust gas channel is provided around said separators.

25. A fuel cell according to claim 23, wherein said fuel gas supply unit is provided hermetically at the central regions of said separators.

26. A fuel cell according to claim 23, wherein said fuel gas inlet is provided at the center of said electrolyte electrode assembly or at an upstream position deviated from the center of said electrolyte electrode assembly in a flow direction of the oxygen-containing gas.

27. A fuel cell according to claim 23, wherein said electrolyte electrode assembly comprises a plurality of electrolyte electrode assemblies, said fuel cell further comprising an oxygen-containing gas supply unit for supplying the oxygen-containing gas before consumption to said oxygen-containing gas supply channel from the inner circumference of said electrolyte electrode assemblies arranged along a virtual circle.

28. A fuel cell according to claim 18, wherein an area where said elastic channel member is provided is larger than a power generation area of said cathode.

29. A fuel cell according to claim 18, wherein said elastic channel member is an electrically conductive metal mesh member.

30. A fuel cell according to claim 18, wherein said protrusions are solid portions formed on one surface of said separator by etching.

31. A fuel cell according to claim 18, wherein said electrolyte electrode assembly comprises a plurality of electrolyte electrode assemblies arranged along a virtual circle concentric with the center of said separators.

32. A fuel cell including an electrolyte electrode assembly and a pair of separators sandwiching said electrolyte electrode assembly, said electrolyte electrode assembly including an anode, a cathode, and an electrolyte interposed between said anode and said cathode, said separators each comprising a single plate, said fuel cell comprising:
a first deformable elastic channel member provided on one surface of said separator to form a fuel gas channel for supplying a fuel gas along an electrode surface of said anode, said first deformable elastic channel member tightly contacting said anode;
a second deformable elastic channel member provided on the other surface on said separator to form an oxygen-containing gas channel for supplying an oxygen-containing gas along an electrode surface of said cathode, said deformable elastic channel member tightly contacting said cathode; and
a channel member provided on the one surface or the other surface of said separator to form a fuel gas supply channel connected to a fuel gas supply unit and a fuel gas inlet for supplying a fuel gas to said fuel gas channel.

33. A fuel cell according to claim 32, further comprising an exhaust gas channel for discharging the fuel gas and the oxygen-containing gas consumed in the reaction in said electrolyte electrode assembly as an exhaust gas in a stacking direction of said electrolyte electrode assembly and said separators, wherein
said fuel gas supply unit for supplying the fuel gas before consumption in the stacking direction is provided hermetically inside said exhaust gas channel; and
said fuel gas supply channel connects said fuel gas channel and said fuel gas supply unit, and is provided along the separator surface to intersect said exhaust gas channel extending in the stacking direction.

34. A fuel cell according to claim 33, wherein said exhaust gas channel is provided at the central regions of said separators.

35. A fuel cell according to claim 33, wherein said fuel gas supply unit is provided hermetically at the central region of said exhaust gas channel.

36. A fuel cell according to claim 32, further comprising an oxygen-containing gas supply unit for supplying the oxygen-containing gas before consumption from the outer circumference of said electrolyte electrode assembly to said oxygen-containing gas supply channel.

37. A fuel cell according to claim 32, further comprising an exhaust gas channel for discharging the fuel gas and the oxygen-containing gas consumed in the reaction in said electrolyte electrode assembly as an exhaust gas in a stacking direction of said electrolyte electrode assembly and said separators; and
an oxygen-containing gas supply unit for allowing the oxygen-containing gas before consumption to flow in the stacking direction to supply the oxygen-containing gas to said oxygen-containing gas channel, wherein
said fuel gas supply unit for supplying the fuel gas before consumption in the stacking direction is provided hermetically inside said oxygen-containing gas supply unit; and
said fuel gas supply channel connects said fuel gas channel and said fuel gas supply unit, and is provided along the separator surface to intersect said oxygen-containing gas supply unit extending in the stacking direction.

38. A fuel cell according to claim 37, wherein said exhaust gas channel is provided around said separators.

39. A fuel cell according to claim 37, wherein said fuel gas supply unit is provided hermetically at the central regions of said separators.

40. A fuel cell according to claim 37, wherein said fuel gas inlet is provided at the center of said electrolyte electrode assembly or at an upstream position deviated from the center of said electrolyte electrode assembly in a flow direction of the oxygen-containing gas.

41. A fuel cell according to claim 37, wherein said electrolyte electrode assembly comprises a plurality of electrolyte electrode assemblies, said fuel cell further comprising an oxygen-containing gas supply unit for supplying the oxygen-containing gas before consumption to said oxygen-containing gas supply channel from the inner circumference of said electrolyte electrode assemblies arranged along a virtual circle.

42. A fuel cell according to claim 32, wherein an area where said second elastic channel member is provided is smaller than an area where said first elastic channel member is provided.

43. A fuel cell according to claim 32, wherein said first and second elastic channel members are electrically conductive metal mesh members.

44. A fuel cell according to claim 32, wherein said electrolyte electrode assembly comprises a plurality of electrolyte electrode assemblies arranged along a virtual circle concentric with the center of said separators.
